(19) United States
(12) Patent Application Publication
(10) Pub. No.: US 2025/0184707 A1
(43) Pub. Date: Jun. 5, 2025

(54) METHOD OF COMMUNICATION APPARATUS, METHOD OF USER EQUIPMENT (UE), COMMUNICATION APPARATUS, AND UE

(71) Applicant: NEC Corporation, Minato-ku, Tokyo (JP)

(72) Inventors: Toshiyuki Tamura, Tokyo (JP); Kundan Tiwari, Tokyo (JP)

(73) Assignee: NEC Corporation, Minato-ku, Tokyo (JP)

(21) Appl. No.: 18/844,194

(22) PCT Filed: Mar. 7, 2023
(86) PCT No.: PCT/JP2023/008555

§ 371 Date: Sep. 5, 2024

(30) Foreign Application Priority Data
Mar. 16, 2022 (IN) 202211014351

(51) Int. Cl. H04W 4/90; H04L 65/1016; H04L 65/1104; H04W 4/12; H04W 4/38; H04W 64/00

(52) U.S. Cl. CPC H04W 4/90; H04L 65/1016; H04L 65/1104; H04W 4/12; H04W 4/38; H04W 64/00

(57) ABSTRACT

An aspect of this disclosure includes a method of a communication apparatus. The method includes sending a message. The message includes a request to send information. The information includes at least one of: an identifier of a user equipment (UE); a location information where the UE locates; video information around the UE; photo information around the UE; sound information around the UE; temperature information around the UE; vital information of a user of the UE; and contact information of the UE. The method includes receiving the information after sending the message.

### TECHNICAL FIELD

The present disclosure relates to a method of a communication apparatus, a method of a User Equipment (UE), a communication apparatus, and a UE.

### BACKGROUND ART

Lifesaving in a disaster is an important task to save people's life. In general, it is a hard task to work as it is difficult to predict when the disaster happens and what kind of disaster happens. To support lifesaving activities after the disaster, the mobile communication system may help. Paging UE and Broadcasting message to UEs are equipped as the fundamental function in the mobile communication system.

### CITATION LIST

### Non Patent Literature

NPL 1: 3GPP TR 21.905: “Vocabulary for 3GPP Specifications”. V17.1.0 (2021-12)
NPL 2: 3GPP TS 23.041: “Technical realization of Cell Broadcast Service (CBS)”. V17.2.0 (2021-09)
NPL 3: 3GPP TS 24.526: “IP Multimedia Subsystem (IMS) emergency sessions”. V17.2.0 (2021-09)
NPL 4: IETF RFC 5580: “Carrying Location Objects in RADIUS and Diameter”. (2009-08)
NPL 5: 3GPP TS 38.331: “NR; Radio Resource Control (RRC) protocol specification”. V16.7.0 (2021-12)
NPL 6: 3GPP TS 36.331: “Evolved Universal Terrestrial Radio Access (E-UTRA); Radio Resource Control (RRC) protocol specification”. V17.2.0 (2021-09)
NPL 7: 3GPP TS 23.167: “IP Multimedia Subsystem (IMS) emergency sessions”. V17.2.0 (2021-09)
NPL 8: 3GPP TS 23.122: “Non-Access-Stratum (NAS) functions related to Mobile Station (MS) in idle mode”. V17.5.0 (2021-12)
NPL 9: 3GPP TS 22.268: “Public Warning System (PWS) requirements”. V16.4.0 (2020-09)
NPL 10: 3GPP TS 24.229: “Session Initiation Protocol (SIP) and Session Description Protocol (SDP) Stage 3”. V17. 5.0 (2021-12)
NPL 11: 3GPP TS 23.228: “IP Multimedia Subsystem (IMS) Stage 2”. V17. 3.0 (2021-12)
NPL 12: 3GPP TS 23.501: “System architecture for the 5G System (5GS)”. V17.3.0 (2021-12)
NPL 13: 3GPP TS 23.502: “Procedures for the 5G System (5GS)”. V17.3.0 (2021-12)
NPL 14: 3GPP TS 23.503: “Policy and charging control framework for the 5G System (5GS) Stage 2”. V17.3.0 (2021-12)

### SUMMARY OF INVENTION

### Technical Problem

When a disaster happens, for example an earthquake, a tsunami or a volcanic eruption, it is very difficult to rescue people in a disaster area as people in the disaster area may be in a serious condition and they may not be able to make an emergency call or their mobile phone (or user equipment) may be out of service because base stations may be damaged by the disaster.

In addition, lifeguards are not needed only in disaster situations, but also in other emergency situations. For example, lifeguards may need to attend to an unconscious person due to falling during mountain climbing, a stray child, or assist in a hostage situation. Even when a lifeguard agent knows that a person needs to be rescued and call the person, the lifeguard agent may not be able to accurately locate the person in emergency e.g., due the person being unable to accept the call or provide sufficient information.

### Solution to Problem

In a first example aspect, a method of a communication apparatus includes: sending a message, wherein the message includes a request to send information, wherein the information includes at least one of identifier of a user equipment (UE), a location information where the UE locates, video information around the UE, photo information around the UE, sound information around the UE, temperature information around the UE, vital information of a user of the UE, and contact information of the UE; and receiving the information after sending the message.

In a second example aspect, a method of a user equipment (UE) includes: receiving a message, wherein the message includes a request to send information, wherein the information includes at least one of identifier of the UE, a location information where the UE locates, video information around the UE, photo information around the UE, sound information around the UE, temperature information around the UE, vital information of a user of the UE, and contact information of the UE; and sending the information after receiving the message.

In a third example aspect, a communication apparatus includes: means for sending a message, wherein the message includes a request to send information, wherein the information includes at least one of identifier of a user equipment (UE), a location information where the UE locates, video information around the

UE, photo information around the UE, sound information around the UE, temperature information around the UE, vital information of a user of the UE, and contact information of the UE; and means for receiving the information after sending the message.

In a fourth example aspect, a user equipment (UE) includes: means for receiving a message, wherein the message includes a request to send information, wherein the information includes at least one of identifier of the UE, a location information where the UE locates, video information around the UE, photo information around the UE, sound information around the UE, temperature information around the UE, vital information of a user of the UE, and contact information of the UE; and means for sending the information after receiving the message.

### Advantageous Effects of Invention

According to the present disclosure, it is possible to provide a method of a communication apparatus, a method of a User Equipment (UE), a communication apparatus, and a UE.

### BRIEF DESCRIPTION OF DRAWINGS

FIG. 1 illustrates schematically an exemplary target period for lifesaving after a disaster.

FIG. 2 illustrates schematically another exemplary target period for lifesaving after a disaster.

FIG. 3 is a flow chart illustrating an exemplary procedure to be taken in a First Aspect.

FIG. 4 is a signalling diagram of a Second example of the First Aspect.

FIG. 5 is a signalling diagram of a variant of the Second example of the First Aspect.

FIG. 6 is a signalling diagram of a Third example of the First Aspect.

FIG. 7 is a signalling diagram of a First example of the Second Aspect.

FIG. 8 is a signalling diagram of a Second example of the Second Aspect.

FIG. 9 is a signalling diagram of a Third example of the Second Aspect.

FIG. 10 is a signalling diagram of a First example of the Third Aspect.

FIG. 11 is a signalling diagram of a Second example of the Third Aspect.

FIG. 12 is a signalling diagram of a Third example of the Third Aspect.

FIG. 13 illustrates schematically a system to which the invention may be applied.

FIG. 14 is a block diagram illustrating a UE.

FIG. 15 is a block diagram illustrating an (R)AN node.

FIG. 16 is a diagram illustrating System overview of (R)AN node based on O-RAN architecture.

FIG. 17 is a block diagram illustrating an RU.

FIG. 18 is a block diagram illustrating a DU.

FIG. 19 is a block diagram illustrating a CU.

FIG. 20 is a block diagram illustrating an AMF.

FIG. 21 is a block diagram illustrating an SMF.

FIG. 22 is a block diagram illustrating a UPF.

FIG. 23 is a block diagram illustrating a PCF.

FIG. 24 is a block diagram illustrating an AUSF.

FIG. 25 is a block diagram illustrating a UDM.

FIG. 26 is a block diagram illustrating an NWDAF.

FIG. 27 is a block diagram illustrating an NEF.

FIG. 28 is a block diagram illustrating an NSACF.

FIG. 29 is a block diagram illustrating an IMS.

FIG. 30 is a block diagram illustrating a PSAP.

### DESCRIPTION OF EMBODIMENTS

### Abbreviations

For the purposes of the present document, the abbreviations given in 3GPP TR 21.905 (NPL 1) and the following apply. An abbreviation defined in the present document takes precedence over the definition of the same abbreviation, if any, in
3GPP TR 21.905 (NPL 1).
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QOS Identifier
AF Application Function
AI Artificial Intelligence
AMF Access and Mobility Management Function
AMF-G Geographically selected Access and Mobility Management Function
AMF-NG Non-Geographically selected Access and Mobility Management
Function
ANDSF Access Network Discovery and Selection Function
AS Access Stratum
ATSSS Access Traffic Steering, Switching, Splitting
ATSSS-LL ATSSS Low-Layer
AUSF Authentication Server Function
AUTN Authentication token
BCCH Broadcast Control Channel
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HPLMN Home Public Land Mobile Network
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In the Middle
ML Machine Learning
MNC Mobile Network Code
MPS Multimedia Priority Service
MPTCP Multi-Path TCP Protocol
MSD Minimum Set of Data
N3IWF Non-3GPP InterWorking Function
N3GPP Non-3GPP access
N5CW Non-5G-Capable over WLAN
NAI Network Access Identifier
NAS Non-Access-Stratum
NEF Network Exposure Function
NF Network Function
NGAP Next Generation Application Protocol
NID Network identifier
NPN Non-Public Network
NR New Radio
NRF Network Repository Function
NSACF Network Slice Admission Control Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PDB Packet Delay Budget
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PSAP Public Safety Answering Point
PTP Precision Time Protocol
QFI QoS Flow Identifier
QoE Quality of Experience
RACS Radio Capabilities Signalling optimisation
(R)AN (Radio) Access Network
RAT Radio Access Technology
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SDP Session Description Protocol
SEAF Security Anchor Functionality
SEPP Security Edge Protection Proxy
SIP Session Initiation Protocol
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UE User Equipment
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
VPLMN Visited Public Land Mobile Network
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in 3GPP TR 21.905 (NPL 1) and the following apply. A term defined in the present document takes precedence over the definition of the same term, if any, in 3GPP TR 21.905 (NPL 1).

### (General)

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

An example object of this disclosure is to provide a method and an apparatus that can solve the above problem.

A method of a communication apparatus according to example aspect of this disclosure includes sending a message. The message includes a request to send information. The information includes at least one of identifier of a user equipment (UE), a location information where the UE locates, video information around the UE, photo information around the UE, sound information around the UE, temperature information around the UE, vital information of a user of the UE, and contact information of the UE. The method includes receiving the information after sending the message.

A method of a user equipment (UE) according to example aspect of this disclosure includes receiving a message. The message includes a request to send information. The information includes at least one of identifier of the UE, a location information where the UE locates, video information around the UE, photo information around the UE, sound information around the UE, temperature information around the UE, vital information of a user of the UE, and contact information of the UE. The method includes sending the information after receiving the message.

A communication apparatus according to example aspect of this disclosure includes a memory, and at least one hardware processor coupled to the memory. The at least one hardware processor is configured to send a message. The message includes a request to send information. The information includes at least one of identifier of a user equipment (UE), a location information where the UE locates, video information around the UE, photo information around the UE, sound information around the UE, temperature information around the UE, vital information of a user of the UE, and contact information of the UE. The at least one hardware processor is configured to receive the information after sending the message.

A User Equipment (UE) according to example aspect of this disclosure includes a memory, and at least one hardware processor coupled to the memory. The at least one hardware processor is configured to receive a message. The message includes a request to send information. The information includes at least one of identifier of the UE, a location information where the UE locates, video information around the UE, photo information around the UE, sound information around the UE, temperature information around the UE, vital information of a user of the UE, and contact information of the UE. The at least one hardware processor is configured to send the information after receiving the message.

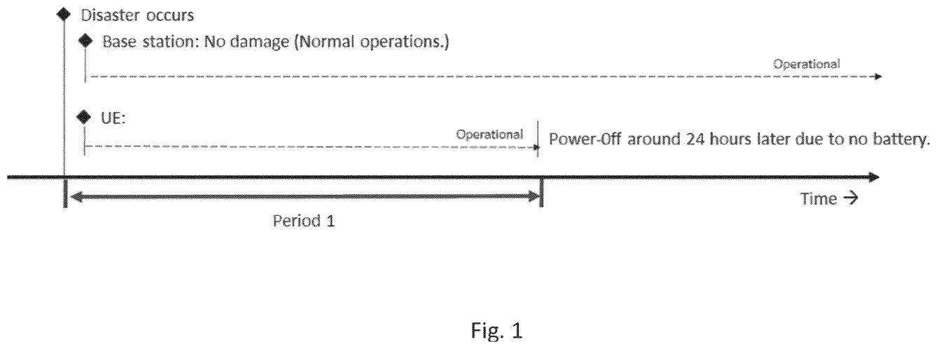

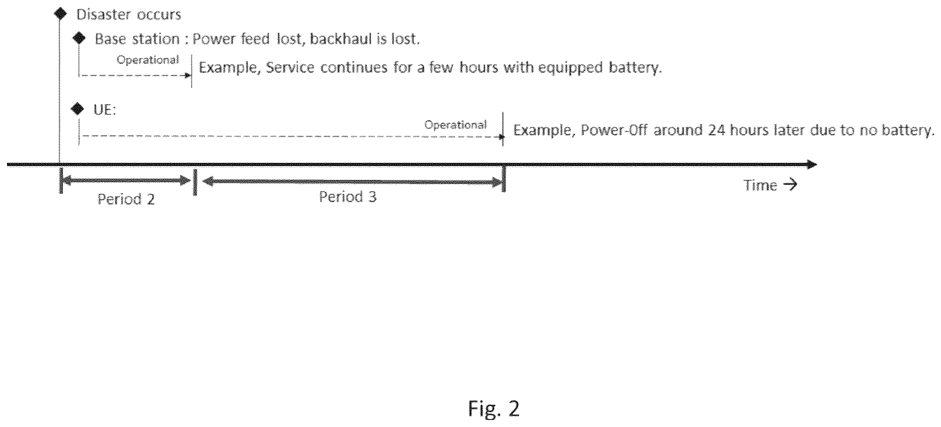

This disclosure refers to FIG. 1 and FIG. 2 to identify which example(s) in this disclosure are applicable for the period(s) depicted in FIG. 1 and FIG. 2.

FIG. 1 is a timeline illustrating an exemplary period after a disaster occurs, and respective states of the base station and the UE. In this case, the base station remains operational (no damage), i.e., power is fed, backhaul connection(s) are maintained. However, the UE remains operational only for a limited period denoted ‘period 1’ in FIG. 1, as the battery of the UE may be depleted after a while (e.g., in 24 hours). It will be appreciated that those who are able to make a phone call, i.e., people that are conscious or not being hostage, are not subject for rescue by this disclosure as they can call the lifeguard agent.

The term “lifeguard agent” throughout this disclosure may refer to, for example, police, fire department, local government, mountain ranger, maritime security agent, self-defense force or military.

FIG. 2 is a timeline illustrating some exemplary periods, and respective states of the base station and the UE after a disaster occurs. In this case, the base station has lost the power feed, thus the base station can be operational only in a limited period (denoted ‘period 2’ in FIG. 2) after the disaster occurs. The UE can also remain operational in a limited period which is shown as period 2 plus period 3 in FIG. 2, as long as the UE's battery has some remaining charge. It will be appreciated that in other scenarios the base station may remain operational for a longer period than the UE, in which case periods 2 and 3 may be defined differently. It will also be appreciated that the respective periods for different UEs and different base stations may be different depending on their battery level and energy consumption (amongst others). For sake of simplicity, a common period (e.g., a single period 2 and/or a single period 3) may be applied for a group of UEs and/or a group of base stations (but not necessarily all UEs and base stations), if appropriate.

### (First Aspect)

This aspect discloses some examples that may be applicable to disaster situations for finding people who need to be rescued in the disaster area. It will be appreciated that the term ‘disaster’ is intended to cover any other crisis event or emergency situation (e.g., hostage situation or any other public safety event). The term ‘disaster area’ used in this disclosure may refer to a geographical area affected by or associated with a disaster or any other crisis/emergency situation. A geographical area may be defined as an area defined by associated latitudes and longitudes, an area comprising a set of cells (at least one cell), an administrative area (e.g., a city, a district, a building, and/or the like), and any combination thereof.

As people in the disaster area are unknown, the main target of outcome of this aspect is for the lifeguard agent to find out UE identities and their location(s). In addition, more detailed information, for example a picture showing an environment around the UE, might be useful for the lifeguard agent to decide what approach to take when attempting to rescue affected people.

### (First Example of the First Aspect)

A First example of the First Aspect discloses a method for finding and rescuing people in the disaster area using the RAN node 5.

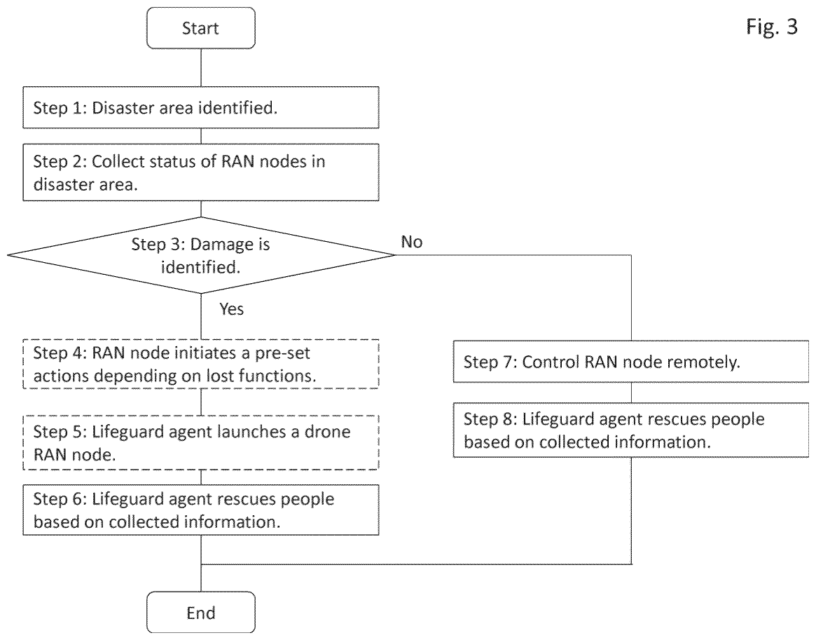

The detailed processes of the First example of the First Aspect are described below, with reference to FIG. 3. FIG. 3 shows an overall rescue procedure.

Step 1. The lifeguard agent identifies the occurrence of a disaster. The lifeguard agent may collect information relating to the disaster. For example, the lifeguard agent may collect information of an area where the disaster occurs. The area where the disaster occurs may be expressed as a disaster area.

Step 2. Based on collected information relating to the disaster, the lifeguard agent collects status information of the RAN node(s) that are installed in the disaster area. The status information of a particular RAN node may indicate whether that RAN node is damaged or otherwise affected by the disaster. The status information of a particular RAN node may indicate whether that particular RAN node(s) is operational.

Step 3. Depending on a status of the RAN node(s) 5, the lifeguard agent takes an appropriate action.

Step 4. If the RAN node(s) 5 is/are damaged, the following actions may be taken depending on the damage (if known).

Note that in addition to the RAN node functions and the so-called LIFE GUARD APL 553, the RAN node(s) 5 may comprise appropriate 5GC functions, CBC functions, and IMS functions in order to execute a search procedure. The LIFE GUARD APL 553 may be an application or a program which is configured to be run in the RAN node 5. For example, a memory in the RAN node 5 may store the LIFE GUARD APL 553 and at least one processor in the RAN node 5 coupled to the memory may run the LIFE GUARD APL 553 for the processes in this disclosure. In this disclosure, the sentence in which the subject is described as the LIFE GUARD APL 553 may be interpreted as a sentence in which the subject is described as the RAN node 5.

{Connections to Core Network/O&M are Lost while Radio Part and Power Supply are Alive}

When the LIFE GUARD APL 553 decides that a search procedure needs to take place based on various inputs, for example a combination of backhaul connection lost and detecting an earthquake of a high magnitude (e.g., above an associated threshold), the LIFE GUARD APL 553 initiates the search procedure as disclosed in a second example of the First Aspect in accordance with the pre-configured program in the DATA STORAGE 5531. In this case, the RAN node 5 takes care of the rescue activities in both period 2 and period 3 in FIG. 2.

{Power Supply is Lost while Connections to Core Network/O&M and Radio Part are Alive}

When the LIFE GUARD APL 553 decides that the search procedure needs to take place based on various inputs, for example a combination of backhaul connection lost and detecting an earthquake of a high magnitude, the LIFE GUARD APL 553 initiates the search procedure as disclosed in a second example of the First Aspect in accordance with the pre-configured program in the DATA STORAGE 5531.

The LIFE GUARD APL 553 may initiate a communication with the lifeguard agent for indicating that the rescue procedure has been initiated by the RAN node(s) 5 and an estimated time when the RAN node(s) 5 will lose battery power. In this case, the RAN node 5 takes care of the search procedures in period 2 shown in FIG. 2.

Step 5. Based on collected information relating to the disaster, the lifeguard agent launches a drone RAN node 5 to the disaster area.

The information from the LIFE GUARD APL 553 in the RAN node(s) 5 can also be referred for a decision making when and where the drone RAN node 5 is required.

For example, the LIFE GUARD APL 553 in the RAN node(s) 5 indicates that the battery in the RAN node(s) 5 lasts at least 5 more hours, then the drone RAN node 5 is launched/deployed to the disaster area where the RAN node(s) 5 is located approximately 5 hours later. In this case, the drone RAN node 5 takes care of the search procedures in period 3 shown in FIG. 2.

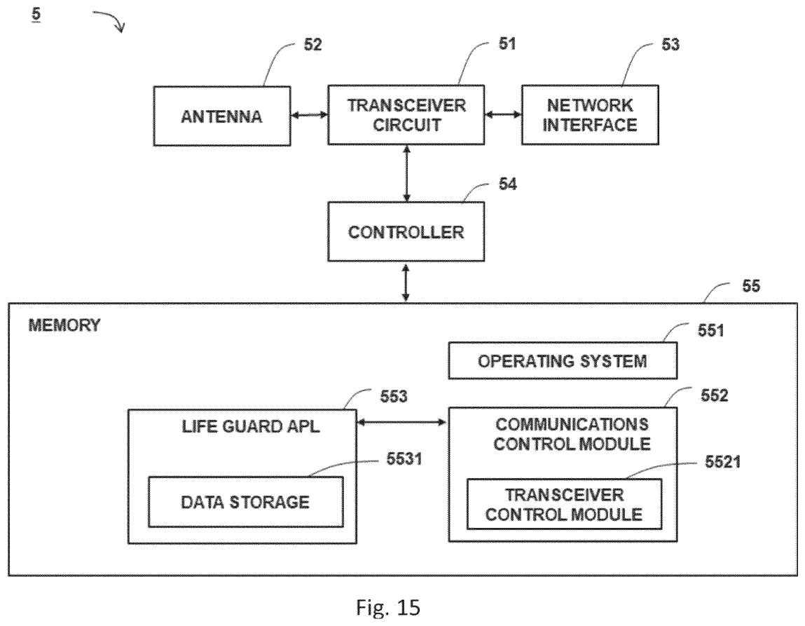

The drone RAN node 5 has one or more of the following features:
The drone RAN node 5 comprises all regular RAN node functions as illustrated in the RAN node 5 in FIG. 15.
In addition, the LIFE GUARD APL 553 in the drone RAN node 5 comprises the 5GC functions, CBC functions and IMS functions in order to execute the search procedure.
The IMS functions in the LIFE GUARD APL 553 may also have a PSAP function that interworks with the IMS function. The PSAP function handles the MSD in the IMS messages and may communicate with the UE 3 using communication path set by the IMS function.
The drone RAN node 5 has a capability to broadcast a PLMN ID that is available in the disaster area. The PLMN ID may be a one that the damaged RAN node 5 belongs to so that all UEs that belong to that PLMN can tune to the drone RAN node 5.
The drone RAN node 5 has a capability to broadcast multiple PLMN IDs that may be available in the disaster area. All PLMN IDs that are in-service in the disaster area are pre-configured in the drone RAN node 5. For example, all PLMN IDs that identify PLMN(s) which are in-service in the disaster area may be pre-configured in the drone RAN node 5. This shared RAN function can help to search UE(s) that has/have some PLMN IDs registered in the prohibited PLMN list in the USIM of the UE.
Once the drone RAN node 5 completes the search procedure, the drone RAN node 5 returns back to a place which may be pre-determined in the program or based on an instruction from the lifeguard agent.

Step 6. Once the regular RAN node 5 or the drone RAN node 5 completes the search procedure, the lifeguard agent starts rescue activity based on information collected during the search procedure in the RAN node 5 and/or the drone RAN node 5.

Step 7. Based on collected information relating to the disaster and information from the RAN node(s) 5 via the O&M connection, the lifeguard agent may instruct the RAN node 5 to initiate the search procedure. As the RAN node 5 processes a traffic for mobile communications including emergency calls, the lifeguard agent may instruct the RAN node 5 to employ a search procedure that does not to affect the traffic processing for mobile communications. For example, the lifeguard agent may use their own UE to perform the above instruction. Step 7 may be performed if the RAN node(s) 5 is/are not damaged.

Step 8. Once the RAN node 5 completes the search procedure, the lifeguard agent starts an appropriate rescue activity based on information collected during the search procedure in RAN node 5.

(Second Example of the First Aspect) A Second example of the First Aspect discloses a search procedure using the PWS and eCALL functions that are defined in 3GPP TS 23.041 (NPL 2) and 3GPP TS 23.167 (NPL 7) respectively. The search procedure provides useful information for the lifeguard agent to find and rescue people in the disaster area.

The RAN node 5 in this example can be a regular RAN node or a drone RAN node.

A LIFEGUARD APL 553 in the RAN node 5 comprises the following functions.
CBC function: The CBC function generates the Write-Request warning request message as defined in 3GPP TS 23.041 (NPL 2). The Write-Request warning request message may be replaced with a Write-Replace warning request message.
AMF and MME function: The AMF and MME function takes care of cell broadcast message handling, mobility management and session management.
SMF, UPF, SGW and PGW, PCRF and PCF functions: These functions take care of session handling for the IMS eCALL.
IMS function: The IMS function takes care of eCALL over IMS as defined in 3GPP TS 23.167 (NPL 7). The eCALL may be expressed as an emergency call.

A LIFEGUARD APL 363 in the UE 3 comprises the following functions.
Public Warning System (PWS) application function: When a warning message in System Information Block, SIB, is received, the LIFEGUARD APL 363 digests the received message and takes an appropriate action based on a request in the received message.
IMS function: The IMS function takes care of eCALL over IMS as defined in 3GPP TS 23.167 (NPL 7).

The LIFE GUARD APL 363 may be an application or a program which is configured to be run in the UE 3. For example, a memory in the UE 3 may store the LIFE GUARD APL 363 and at least one processor in the UE 3 coupled to the memory may run the LIFE GUARD APL 363 for the processes mentioned in this disclosure. In this disclosure, the sentence in which the subject is described as the LIFE GUARD APL 363 may be interpreted as a sentence in which the subject is described as the UE 3.

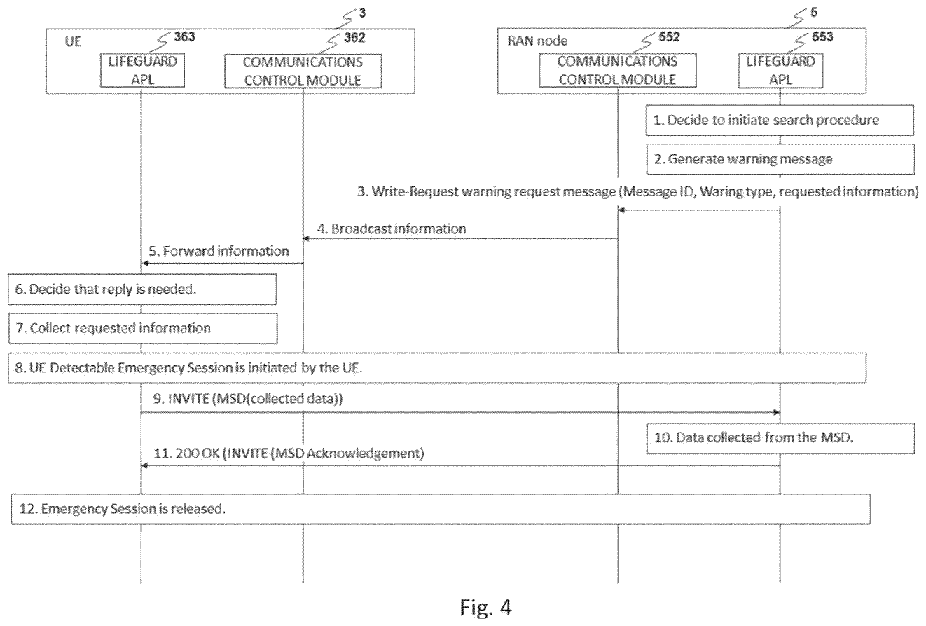

The detailed processes of the Second example of the First Aspect are described below with reference to FIG. 4. FIG. 4 shows a search procedure with an eCALL.

Step 1. The RAN node 5 decides to initiate the search procedure. This decision can be made solely by the RAN node 5 based on pre-configured decision-making criteria in the RAN node 5 or instructed by the lifeguard agent (e.g., via O&M communication and/or the like). For example, in a case where the RAN node 5 determines that it is in a disaster situation, the RAN node 5 may decide to initiate the search procedure. For example, the RAN node 5 may determine that it is in a disaster situation based on information obtained by the RAN node 5 or received from other communication apparatus. The information obtained by the RAN node 5 or received from other communication apparatus may indicate the occurrence of a disaster. For example, in case of an earthquake, the RAN node 5 may obtain the information which indicates occurrence of the earthquake by using at least one sensor which is capable to obtain seismic intensity.

Step 2. Based on a disaster situation (e.g., in a case where the RAN node 5 determines that it is in the disaster situation) or an instruction from the lifeguard agent, the LIFEGUARD APL 553 generates the Write-Request warning request message including a Message ID, Warning type and Requested information parameters. The Write-Request warning request message may be replaced with a Write-Replace warning request message. The instruction from the lifeguard agent may be an instruction to initiate the search procedure or an instruction to generate the Write-Request warning request message. The following bullet points explain some exemplary details of each parameter that may be included in the Write-Request warning request message.
Message ID: information that identifies the broadcasted message. In this example, it could mean that “This is a request for data collection for lifesaving purpose due to disaster”. This message ID is read by the UE 3 and routed to the LIFEGUARD APL 363 in the UE 3.
Warning type: The warning type indicates a type of warning. In this example, it could be for example “Data requested due to disaster”. This parameter is read by the UE 3 and may be routed to the LIFEGUARD APL 363.
Requested information: This is a message to the LIFEGUARD APL 363 in the UE 3. This Requested information may include:
#Notification mode: Notification mode may indicate whether a warning to the UE 3 is required or not. If warning is required, a type of warning is also indicated. For example, the type of warning may indicate at least one of: beeping sound, loudness level, vibrations, and pop-up message. If warning is not required, the LIFEGUARD APL 363 in the UE 3 performs any requested process(es) in the background in order to avoid being perceived by a user of the UE 3 and/or other people nearby.
#Warning message in text: Human readable warning message.
#User consent required: This indicates that a user consent is required by a user of the UE 3 for sending information to the LIFEGUARD APL 553 in the RAN node 5.
#Requested information:
   UE identifier: It may be IMSI, SUPI, and/or MSISDN number of the UE (or any other any suitable identifier associated with the user or the UE 3).
   UE location: UE location may be given in GPS format, or a location expressed with civic and geospatial location formats as defined in IETF RFC 5580 (NPL 4)
   Video: Requested to take a video clip of surrounding view.
   Photo: Requested to take a photograph of surrounding view.
   Sound: Requested to record a sound where the UE is located.
   Air temperature: Requested to measure air temperature where the UE is located.
   Vital information: Requested to measure vital information if available. This may be measured if the UE is or it is connected to a smart watch or similar.
   Contact information: Requested to report contact information of the user. The Requested information may indicate information to be acquired by the UE 3.

Note that the Requested information can be a normalized information. For example, expressed by a numeric character. In this case, a meaning of the normalized information is shared in advance between the LIFEGUARD APL 363 and LIFEGUARD APL 553. This normalization may help reduce the volume of data to be transferred to the LIFEGUARD APL 363 in the UE 3.

Step 3. The AMF function or the MME function in the LIFEGUARD APL 553 sends the Write-Request warning request message to the RAN node function in the COMMUNICATIONS CONTROL MODULE 552 including the Message ID, the Warning type, the Requested information and another parameter according to the 3GPP TS 23.041 (NPL 2). The Write-Request warning request message may be replaced with a Write-Replace warning request message.

Step 4. The RAN node function in the COMMUNICATIONS CONTROL MODULE 552 broadcasts the Requested information over the BCCH. The RAN node function in the COMMUNICATIONS CONTROL MODULE 552 may broadcast the Write-Request warning request message.

The Requested information or the Write-Request warning request message may be broadcasted in the SIB6 as ETWS primary notification and/or in the SIB7 as ETWS secondary notification and/or in the SIB8 as CMAS notification if the RAN node 5 supports NG-RAN function.

The Requested information or the Write-Request warning request message may be broadcasted in the SIB10 as ETWS primary notification and/or in the SIB11 as ETWS secondary notification and/or in the SIB12 as CMAS notification if the RAN node 5 supports E-UTRAN function.

Step 5. Upon reception of the broadcasted message over the BCCH by the COMMUNICATIONS CONTROL MODULE 362 in the UE 3, the COMMUNICATIONS CONTROL MODULE 362 forwards the received message to the LIFEGUARD APL 363 in the UE 3.

The LIFEGUARD APL 363 may be chosen as the destination of the application by the COMMUNICATIONS CONTROL MODULE 362 by referring to the received value of messageIdentifier or serialNumber, or both messageIdentifier and serialNumber over the SIB according to 3GPP 38.331 (NPL 5) and 3GPP 36.331 (NPL 6) for NG-RAN and E-UTRAN respectively.

The LIFEGUARD APL 363 may be chosen as the destination of the application by the COMMUNICATIONS CONTROL MODULE 362 by referring to the received value of Message ID and/or Warning type in the warning request message that corresponds to the Message ID and Warning type that are set by the LIFEGUARD APL 553 in step 2.

Note that the broadcasted message in step 4 can be received by the UE 3 even when the UE 3 is in limited service state according to section 4.6.4 in 3GPP 22.268 (NPL 9). With this reason, any device in the disaster area can receive the broadcasted message in step 4.

Step 6. The LIFEGUARD APL 363 in the UE 3 analyzes the received message and may decide to either ignore this message or perform the reporting procedure. For example, the LIFEGUARD APL 363 may decide to perform the reporting procedure based on the information included in the requested message. For example, the LIFEGUARD APL 363 may decide to perform the reporting procedure in a case where the requested message includes the Requested information. In a case where the LIFEGUARD APL 363 decides to perform the reporting procedure, the LIFEGUARD APL 363 may perform a process in step 7 described below, as the reporting procedure. For example, the LIFEGUARD APL 363 may decide to ignore the message in a case where the requested message does not include the Requested information.

In addition, regardless of the decision above, the LIFEGUARD APL 363 may take the following actions.
Based on the received Notification mode, the LIFEGUARD APL 363 may make a warning beeping, play an alerting sound or vibrate the UE 3 in order to notify/alert the user of the UE 3.
If the warning message is received, the received message may be displayed on a user display of the UE 3 or read out by a voice generation application in the UE 3.

A public key pre-configured in the DATA STORAGE 3631 in the LIFEGUARD APL 363 can be used for validating the sender if the received message has a digital signature.

Step 7. Once the LIFEGUARD APL 363 decides to initiate the reporting procedure in step 6, the LIFEGUARD APL 363 collects all necessary data as per requested by the LIFEGUARD APL 553 in step 2.

For example, one or more of the following actions may be taken by the UE 3:
If the Notification mode indicates that warning to the UE 3 is not required, then all processes that the LIFEGUARD APL 363 takes in step 7 may be executed secretly (as a background process) in order to avoid being perceived by a user of the UE 3 and/or other people nearby. Otherwise (e.g. if the Notification mode indicates that warning to the UE is required), the LIFEGUARD APL 363 may make a warning beeping, play an alerting sound or vibrate the UE 3 to notify/alert the user of the UE 3 based on an indication in Notification mode parameter.
If the warning message is received, the received message is displayed on a user display of the UE 3 or read out by a voice generation application in the UE 3.
If User consent is required, the LIFEGUARD APL 363 asks the user of the UE 3 to indicate their preference regarding whether data reporting should be allowed or not. For example, this user consent may be one of the following processes.
#Popping up a message asking the user to press a button.
#Asking to say YES or NO over an equipped speaker by a voice generating application.
#User consent can be made with a negative question. For example, the equipped speaker may ask the user “Cry or Speak up any words if you don't want to report”. This may help in case that the user of the UE 3 is unconscious and cannot take any actions. For example, on the basis of results of the asking, the LIFEGUARD APL 363 may determine whether to perform the data collection and reporting of the collected data as mentioned below. For example, in a case where a microphone which is equipped in the UE 3 does not detect any speech/sound by the user, the LIFEGUARD APL 363 may perform the data collection and reporting of the collected data as mentioned below. For example, in a case where the microphone detects speech/sound by the user, the LIFEGUARD APL 363 may not perform the data collection and reporting of the collected data as mentioned below.
The following data collection may be executed.
#If a UE identifier is requested (e.g., the Requested information includes UE identifier), the LIFEGUARD APL 363 obtains an identifier of the UE 3 (e.g., at least one of an IMSI, SUPI, and MSISDN number of the UE 3). The LIFEGUARD APL 363 may obtain the identifier of the UE 3 from the memory of the UE 3.
#If UE location is requested (e.g., the Requested information includes UE location), the LIFEGUARD APL 363 obtains a current location of the UE 3 by interworking with the positioning/GPS application in the UE 3. The current location may be expressed as location information where the UE 3 locates.
#If Video is requested (e.g., the Requested information includes Video), the LIFEGUARD APL 363 makes a video clip of the UE's surroundings by interworking with the Video application and camera(s) of the UE 3. The LIFEGUARD APL 363 may make a video clip of the environment or scene around the UE 3. The video clip may be expressed as video information.
#If Photo is requested (e.g., the Requested information includes Photo), the LIFEGUARD APL 363 takes a few photographs of the UE's surroundings by interworking with the Camera application and camera unit(s) of the UE 3. The LIFEGUARD APL 363 may take a photograph of the environment or scene around the UE 3. The photograph may be expressed as photo information or picture information.
#If Sound is requested (e.g., the Requested information includes Sound), the LIFEGUARD APL 363 records in one or more audio file any noise/sound at the UE's location by interworking with the Recoding application and the microphone of the UE 3. The LIFEGUARD APL 363 may record sound of the environment or scene around the UE 3. The audio file or the sound may be expressed as sound information.
#If Air temperature is requested (e.g., the Requested information includes Air temperature), the LIFEGUARD APL 363 measures an air temperature by interworking with the thermometer application in the UE 3. The LIFEGUARD APL 363 may measure or obtain an air temperature of the UE's environment. The LIFEGUARD APL 363 may measure or obtain information regarding weather conditions around the UE 3. The measured temperature may be expressed as temperature information.
#If Vital information is requested (e.g., the Requested information includes Vital information), the LIFEGUARD APL 363 measures vital information and/or accesses any pre-recorded vital information in the UE 3 to obtain the vital information by interworking with the health monitoring application in the UE 3. The LIFEGUARD APL 363 may measure or obtain vital information of the user of the UE 3. The vital information may include vital signs such as body temperature, heart rate, respiratory rate, blood pressure and so on.
#If Contact information is requested (e.g., the Requested information includes Contact information), the LIFEGUARD APL 363 provides the telephone number of the user of the UE 3 and/or a pre-set telephone number (e.g., the number of an emergency contact), relationship to the user of the UE 3 etc. For example, the contact information to return can be a family member's telephone number (e.g., the telephone number of a spouse or parent) and current residence address. In one example, the LIFEGUARD APL 363 obtains at least some (or all) contact information stored in the UE 3 by interworking with an address book application in the UE 3.

Step 8. The LIFEGUARD APL 363 in the UE 3 initiates the UE Detectable Emergency Session procedure as specified in section 7.7.1 in 3GPP TS 23.167 (NPL 7).

Note that the UE 3 can initiate the UE Detectable Emergency Session procedure even while the UE 3 is in the limited service state according to section 3.5 in 3GPP 23.122 (NPL 8). With this reason, any device in the disaster area can initiate the UE Detectable Emergency Session procedure as far as the UE 3 is 3GPP compliant.

Step 9. The LIFEGUARD APL 363 in the UE 3 sends an initial emergency SIP INVITE message to the LIFEGUARD APL 553 in the RAN node 5 including MSD, eCall type of emergency service indicator and other parameters. The MSD includes the data collected by the UE 3 in step 7. The eCall type of emergency service indicator can be either automatic or manual according to the configuration set by the lifeguard agent. The collected data may include at least one of the identifier of the UE 3, the location of the UE 3, the photograph, the audio file, the air temperature, the vital information, and the contact information as mentioned in step 7.

Step 10. Upon reception of the initial emergency SIP INVITE message by the LIFEGUARD APL 553 in the RAN node 5, the LIFEGUARD APL 553 stores the received MSD to the DATA STORAGE 5531 in the RAN node 5.

Step 11. The LIFEGUARD APL 553 in the RAN node 5 sends a 200 OK message to the LIFEGUARD APL 363 in the UE 3 including MSD acknowledgement.

Step 12. After successful MSD transfer from UE 3 to RAN node 5, the Emergency session is released by either the LIFEGUARD APL 553 or the LIFEGUARD APL 363. For example, in a case where the LIFEGUARD APL 363 in the UE 3 receives the 200 OK message, the LIFEGUARD APL 363 may release the Emergency session. For example, in a case where the LIFEGUARD APL 553 in the RAN node 5 sends the 200 OK message, the LIFEGUARD APL 553 may release the Emergency session.

After step 12, the lifeguard agent may collect and refer data in the DATA STORAGE 5531 in the RAN node 5 and take appropriate rescue actions based on the collected data in the DATA STORAGE 5531. For example, in a case where the LIFEGUARD APL 553 stores the received MSD, the LIFEGUARD APL 553 may notify, to the life guard agent (e.g. an UE of the lifeguard agent) that the RAN node 5 has the collected data. Then the lifeguard agent may collect and refer data in the DATA STORAGE 5531 in the RAN node 5.

### (Variant 1 of Second Example of the First Aspect)

After the LIFEGUARD APL 553 in the RAN node 5 stores the received MSD to the DATA STORAGE 5531 in step 10 in FIG. 4, the LIFEGUARD APL 553 may request additional data to the LIFEGUARD APL 363 in the UE 3.

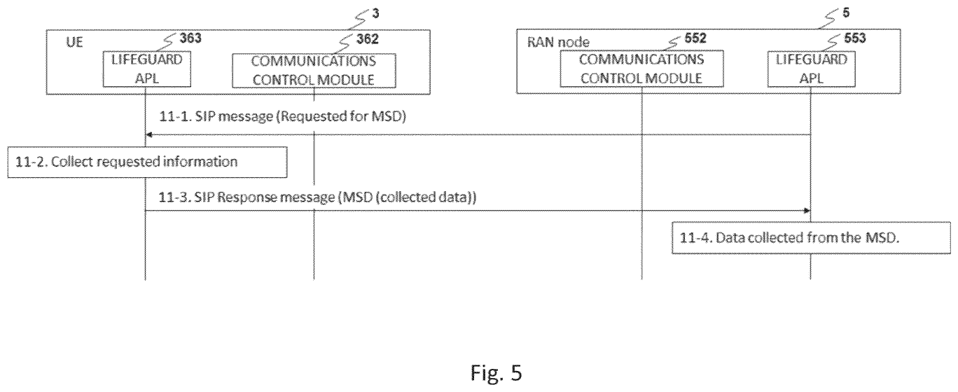

In this case, the following steps in FIG. 5 may be taken between step 11 and step 12 of FIG. 4. FIG. 5 shows an MSD request procedure.

Step 11-1. The LIFEGUARD APL 553 in the RAN node 5 sends a SIP message to the LIFEGUARD APL 363 in the UE 3 including Requested for MSD. The Requested for MSD may include all or some of the Requested information as described in step 2 of FIG. 4. In one example, the SIP message in step 11-1 is a SIP INFO method message.

Step 11-2. Upon reception of the SIP message in step 11-1, the LIFEGUARD APL 363 collects all necessary data as per requested by the LIFEGUARD APL 553 in step 11-1. Refer to step 7 in FIG. 4 for data collection process by the LIFEGUARD APL 363.

Step 11-3. The LIFEGUARD APL 363 sends a SIP Response message to the LIFEGUARD APL 553 in the RAN node 5 including MSD. In one example, the SIP Response message in step 11-3 is a SIP INFO method message. The MSD may include the collected data by the LIFEGUARD APL 363 in step 11-2.

Step 11-4. Upon reception of the SIP Response message by the LIFEGUARD APL 553 in the RAN node 5, the LIFEGUARD APL 553 stores the received MSD to the DATA STORAGE 5531 in the RAN node 5.

### (Third Example of the First Aspect)

A Third example of the First Aspect discloses a search procedure using the PWS and Emergency call functions that are defined in 3GPP TS 23.041 (NPL 2) and 3GPP TS 23.167 (NPL 7) respectively. The search procedure provides useful information for the lifeguard agent to find and rescue people in the disaster area.

The RAN node 5 in this example can be a regular RAN node or a drone RAN node.

A LIFEGUARD APL 553 in the RAN node 5 comprises one or more of the following functions:
CBC function: The CBC function generates the Write-Request warning request message as defined in 3GPP TS 23.041 (NPL 2). The Write-Request warning request message may be replaced with a Write-Replace warning request message.
AMF and MME function: The AMF and MME function takes care of cell broadcast message handling, mobility management and session management.
SMF, UPF, SGW and PGW, PCRF and PCF functions: These functions take care of session handling for the IMS eCALL.
IMS function: The IMS function takes care of Emergency call over IMS as defined in 3GPP TS 23.167 (NPL 7).
Communication function: The communication function takes care of a communication with a user of the UE 3 (e.g., via a user interface). Based on a conversation with the user, the communication function understands a situation that the user is facing and finds the best way to rescue the user if needed. The communication function may be realized by a software in the LIFEGUARD APL 553 that is capable of the voice recognition and voice generation to make a conversation with the user, for example, using AI and ML technologies.

Alternatively, the voice communication may take place with a rescue worker/the lifeguard agent. In this case, a dedicated data connection between the lifeguard agent (UE of the lifeguard agent) and LIFEGUARD APL 553 is established and uses the data connection for voice communication between the user using the UE 3 and the rescue worker/the lifeguard agent via the RAN node 5.

A LIFEGUARD APL 363 in the UE 3 comprises the following functions.
Public Warning System (PWS) application function: When a warning message in System Information Block, SIB, is received, the LIFEGUARD APL 363 digests the received message and takes an appropriate action based on a request in the received message.
IMS functions: The IMS function takes care of eCALL over IMS as defined in 3GPP TS 23.167 (NPL 7).

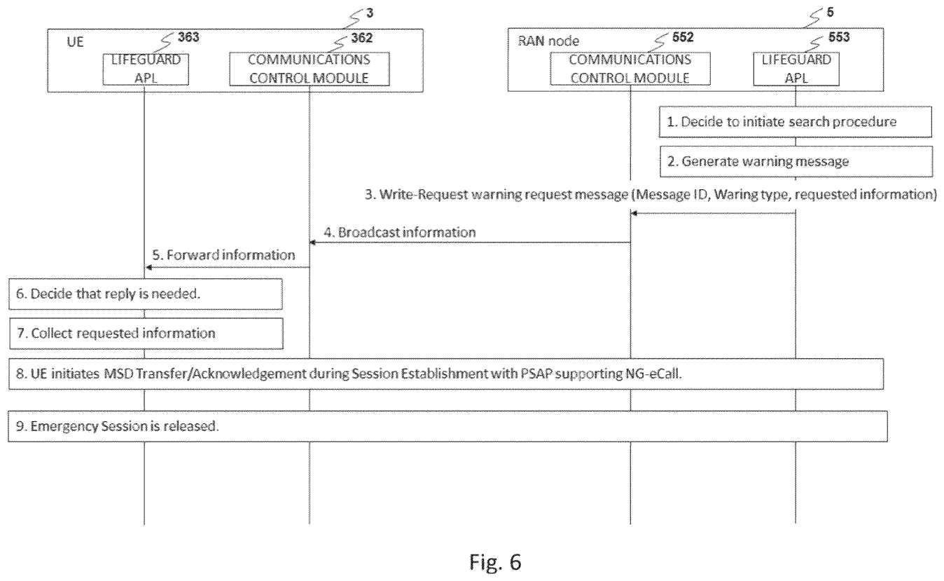

The detailed processes of the Third example of the First Aspect are described below with reference to FIG. 6. FIG. 6 shows a search procedure with an emergency call.

Steps 1-7. Steps 1 to 7 are the same as steps 1 to 7 in FIG. 4.

Step 8. The LIFEGUARD APL 363 in the UE 3 initiates the MSD Transfer/Acknowledgement during Session Establishment with PSAP supporting NG-eCall procedure as specified in section 7.7.1 in 3GPP TS 23.167 (NPL 7). In step 8, the data collected in step 7 may be sent to the RAN node 5. The LIFEGUARD APL 553 may store the received MSD including the collected data to the DATA STORAGE 5531 in the RAN node 5.

The LIFEGUARD APL 553 in the RAN node 5 collects or determines a situation that the user of the UE 3 is facing and finds the best way to rescue the user if needed. For example, the LIFEGUARD APL 553 may inform at least one of the situation and the best way to rescue the user to the lifeguard agent (e.g. UE of the lifeguard agent). The at least one of the situation and the best way to rescue the user may be included in the collected data, and may be sent to the RAN node 5.

For example, on the basis of the collected data, the LIFEGUARD APL 553 in the RAN node 5 may collect a situation that the user of the UE 3 is facing and find the best way to rescue the user if needed.

For example, the LIFEGUARD APL 553 may send the UE location in the collected data to other communication apparatus that has location information indicating an area where the disaster occurs. Then the communication apparatus determines that the user of the UE 3 is or may be affected by the disaster in a case where the location indicated by the UE location corresponds to the area indicated by the location information. Then the communication apparatus sends, to the LIFE GUARD APL 553, information indicating that the user of the UE 3 is or may be affected by the disaster. Then the LIFE GUARD APL 553 collects the information indicating that the user of the UE 3 is or may be affected by the disaster as the situation associated with that user (or UE 3). For example, the LIFEGUARD APL 553 may determine that a fire engine and an ambulance are needed as the best way to rescue the user.

For example, on the basis of the UE location in the collected data and location information indicating an area where the disaster occurs, the LIFEGUARD APL 553 in the RAN node 5 may perform the above determination whether the user of the UE 3 is or may be affected by the disaster. In this case, the LIFEGUARD APL 553 may obtain the location information indicating an area where the disaster occurs from other communication apparatus.

For example, in a case where the video clip or the photograph in the collected data indicates that a fire occurs (or indicates a fire hazard), the LIFEGUARD APL 553 in the RAN node 5 determines that the user of the UE 3 is at a risk of fire, and determines that a fire engine is needed as the best way to rescue the user.

For example, in a case where the audio file in the collected data includes (or identified as) a scream or a similar sound, the LIFEGUARD APL 553 in the RAN node 5 determines that the user of the UE 3 is facing a dangerous situation, and determines that calling police is needed as the best way to rescue the user.

For example, in a case where the air temperature in the collected data indicates low temperature and the vital information in the collected data indicates the user is in a serious condition, the LIFEGUARD APL 553 in the RAN node 5 determines that the life of the user of the UE 3 is in danger, and determines that an ambulance is needed as the best way to rescue the user.

In addition, once a connection for voice communication has been established between the UE 3 and the LIFEGUARD APL 553, the user of the UE 3 talks with (or via) the communication function in the LIFEGUARD APL 553 and explains a situation that the user is facing and finds the best way to rescue the user if needed.

Note that the UE 3 can initiate the MSD Transfer/Acknowledgement during Session Establishment with PSAP supporting NG-eCall procedure even when the UE 3 is in the limited service state according to section 3.5 in 3GPP 23.122 (NPL 8). With this reason, any device in the disaster area can initiate the MSD Transfer/Acknowledgement during Session Establishment with PSAP supporting NG-eCall procedure as far as the UE 3 is 3GPP compliant.

Step 9. After a successful MSD Transfer/Acknowledgement during Session Establishment with PSAP supporting NG-eCall procedure, the Emergency session is released by either the LIFEGUARD APL 553 or the LIFEGUARD APL 363.

After step 9, the lifeguard agent may collect/receive data from the MSD and store the data to the DATA STORAGE 5531 in the RAN node 5. Then, the lifeguard agent may refer to the collected data in the DATA STORAGE 5531 in the RAN node 5 and take appropriate rescue actions based on the collected data in the DATA STORAGE 5531 and any conversation with the user. For example, in a case where the LIFEGUARD APL 553 stores the collected data, the LIFEGUARD APL 553 may notify the life guard agent (e.g., a UE of the lifeguard agent) that the RAN node 5 has collected data. Then the lifeguard agent may collect and refer to the data in the DATA STORAGE 5531 in the RAN node 5.

### (Variant 1 of Third Example of the First Aspect)

In case that the UE 3 cannot provide the location information to the LIFEGUARD APL 553, for example the UE 3 does not have a GPS function, and the RAN node 5 is a drone RAN node 5, the following steps may be taken for finding an accurate location of the UE 3.
After a connection for voice communication has been established between the UE 3 and the LIFEGUARD APL 553 in step 8, the drone RAN node 5 may maintain the connection and start measuring a signal strength of a radio signal from the UE 3 (e.g., a reference signal or any other suitable signal).
The drone RAN node 5 may measure a signal from the UE 3 by rotating an antenna direction and/or using beamforming and/or using other radio technology.
Based on multiple measurement results, the drone RAN node 5 finds an accurate location of the UE 3.
The drone RAN node 5 may move closer to the UE 3 based on the measurement results. In this case, the LIFEGUARD APL 553 may add a connection for video media between the LIFEGUARD APL 553 and UE 3 in addition to the connection for voice communication using a native IMS capability to find and recognize the user visually.

### (Second Aspect)

This aspect discloses some examples that are effective to find a location and determine a situation of a known person who needs a rescue due to emergency. For example, in one use case a person might be unconscious due to falling during a mountain climbing (or any similar accident). In this case, the lifeguard agent may know the person who needs to be rescued in advance as the mountain climber may have submitted a climbing plan with personal data including his/her telephone number.

### (First Example of the Second Aspect)

A First example of the Second Aspect discloses a search procedure using IMS functions as defined in 3GPP TS 23.228 (NPL 11). The search procedure is particularly useful for obtaining information regarding a user's location and situation in case that the user is known or deemed to be in an emergency situation.

A PSAP 202 comprises the following functions.
IMS function: The IMS function takes care of IMS calls as defined in 3GPP TS 23.228 (NPL 11).
Warning message handling function: In order to support the search function, the PSAP 202 generates a warning message and sends it to the IMS (e.g., CSCF) 201. The PSAP 202 also receives collected data from the IMS (e.g., CSCF) 201. The IMS 201 may be CSCF or may include CSCF.

A LIFEGUARD APL 363 in the UE 3 comprises the following functions.
IMS function: The IMS function takes care of IMS calls as defined in 3GPP TS 23.228 (NPL 11).
Warning message handling function: When an IMS message including a warning indication is received, the LIFEGUARD APL 363 digests the received message and takes an appropriate action based on a request in the received message.

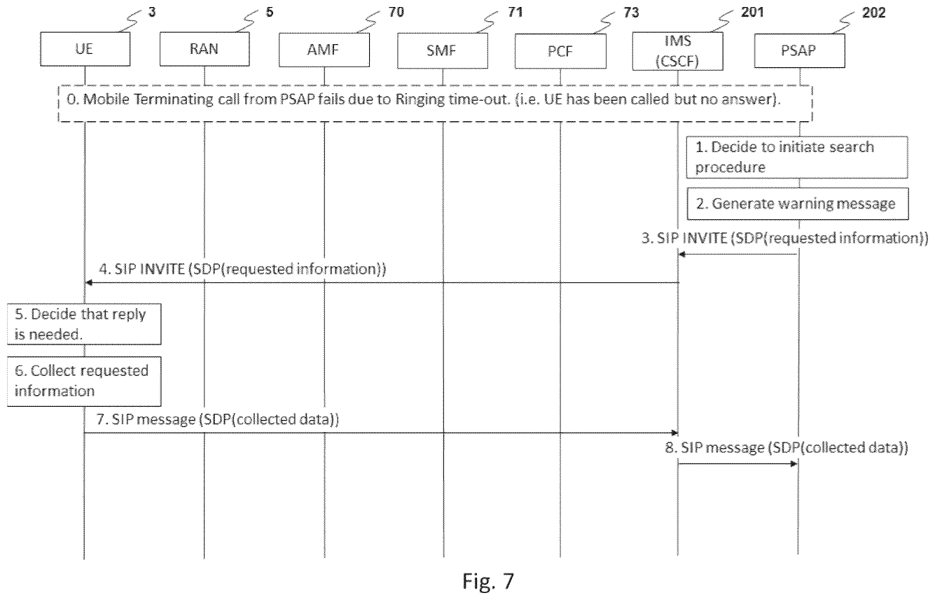

The detailed processes of the First example of the Second Aspect are described below with reference to FIG. 7. FIG. 7 shows a person finding procedure using an IMS.

Step 0. A PSAP 202 makes (initiates) a call to a person who is suspected to be involved in an accident. For example, a worker uses the PSAP 202 to make a call to the person suspected to be involved in an accident. For example, if a mountain climber does not come back on schedule from a mountain, the worker uses the PSAP 202 to make a call to the mountain climber.

If the person (a user of the UE 3) does not answer the call, the worker may consider that the person finding procedure in this disclosure might help to find the person (in case that person is not be able to answer the call due to an injury or accident in the mountain).

Note that step 0 may not take place for example if the PSAP worker tries to contact a hostage.

Step 1. The PSAP 202 decides to make (initiate) a call to find a user of the UE 3 who may not able to answer or react to the call. In this example, the worker uses the PSAP 202 to decide whether to make a call to find a user of the UE 3 who may not able to answer or react to the call. For example, the PSAP 202 may decide to initiate a search procedure in the step 1 in a case where the worker instructs the PSAP 202 to initiate the search procedure. For example, the worker may decide to initiate the search procedure and instruct the PSAP 202 to initiate the search procedure. The worker may decide to initiate the search procedure in a case where the worker makes a call to the user of the UE but there is no answer/reaction from the user.

Step 2. The PSAP 202 generates a SIP INVITE message including a Requested information. The contents of the Requested information can be the same as the Requested information that is described in step 2 of FIG. 4. The Requested information may be expressed by parameters in the existing Session Initiation Protocol (SIP), and the associated Session Description Protocol (SDP) as defined in 3GPP TS 24.229 (NPL 10).

Step 3. The PSAP 202 sends the SIP INVITE message including a user ID and the Requested information. The user ID may be a public user identity, may be a Tel URI, or a SIP URI of the UE 3.

Step 4. The IMS (e.g., CSCF) 201 forwards the SIP INVITE message received in step 3 to the UE 3.

Step 5. The UE 3 receives the SIP INVITE message. The LIFEGUARD APL 363 in the UE 3 analyzes the received message and may decide to either ignore this message or perform the reporting procedure. For example, the LIFEGUARD APL 363 may decide to perform the reporting procedure based on the information included in the SIP INVITE message. For example, the LIFEGUARD APL 363 may decide to perform the reporting procedure in a case where the SIP INVITE message includes the Requested information. In a case where the LIFEGUARD APL 363 decides to perform the reporting procedure, the LIFEGUARD APL 363 may perform a process in step 6 described below, as the reporting procedure. For example, the LIFEGUARD APL 363 may decide to ignore the message in a case where the requested message does not include the Requested information.

In addition, regardless of the decision above, the LIFEGUARD APL 363 may take the one or more of the following actions:
Based on the received Notification mode, the LIFEGUARD APL 363 may make a warning beeping, play an alerting sound or vibrate the UE 3 to notify/alert the user of the UE 3.
If the warning message is received, the received message is displayed on a user display of the UE 3 or read out by a voice generation application in the UE 3.

Step 6. Once the LIFEGUARD APL 363 decides to initiate the reporting procedure in step 5, the LIFEGUARD APL 363 collects all necessary data as requested by the PSAP 202 in step 2.

The following actions may be taken as an example in the UE 3.
If the Notification mode indicates that warning to the UE is not required, then all process that the LIFEGUARD APL 363 takes in this step 6 may be executed secretly in the background in order not be perceived by the user of the UE 3 and people nearby. Otherwise (e.g., if the Notification mode indicates that warning to the UE is required), the LIFEGUARD APL 363 may make a warning beeping, play an alerting sound or vibrate the UE 3 to notify/alert the user of the UE 3 based on an indication in the Notification mode parameter.
If the warning message is received, the received message is displayed on a user display of the UE 3 or read out by a voice generation application in the UE 3.
If User consent is required, the LIFEGUARD APL 363 asks the user of the UE 3 to indicate their preference regarding whether data reporting should be allowed or not. For example, user consent can be obtained using any one of the following processes (or any combination thereof):
#Popping up a message asking the user to press a button.
#Asking to say YES or NO over an equipped speaker by a voice generating application.
#User consent or preference may be obtained using a negative question. For example, the equipped speaker may ask the user to “Cry or Speak up any words if you don't want to report”. This may be helpful in cases where the user of the UE 3 is unconscious and cannot speak or take any action. For example, on the basis of the results of asking the user, the LIFEGUARD APL 363 may determine whether to perform the data collection and reporting of the collected data as mentioned below. For example, in case the UE 3 (using its microphone) does not detect any words or sound by the user, the LIFEGUARD APL 363 may perform the data collection and reporting of the collected data as mentioned below. For example, in a case where the microphone detects words or sound by the user, the LIFEGUARD APL 363 may not perform the data collection and reporting of the collected data mentioned below.
The following data collection may be executed.
#If a UE identifier is requested (e.g., the Requested information includes UE identifier), the LIFEGUARD APL 363 obtains an identifier of the UE 3 (e.g., IMSI, SUPI or MSISDN number of the UE 3). The LIFEGUARD APL 363 may obtain the identifier of the UE 3 from the memory of the UE 3.
#If UE location is requested (e.g., the Requested information includes UE location), the LIFEGUARD APL 363 obtains a current location of the UE 3 (for example, by interworking with the GPS application in the UE 3).
#If Video is requested (e.g., the Requested information includes Video), the LIFEGUARD APL 363 makes a video clip of the UE's surroundings by interworking with the Video application and camera unit(s) of the UE 3.
#If Photo is requested (e.g., the Requested information includes Photo), the LIFEGUARD APL 363 takes a few photographs of the UE's surroundings by interworking with the Camera application and unit(s) of the UE 3.
#If Sound is requested (e.g., the Requested information includes Sound), the LIFEGUARD APL 363 records in one or more audio files any noise/sound at the UE's location by interworking with the Recoding application and microphone of the UE 3.
#If Air temperature is requested (e.g., the Requested information includes Air temperature), the LIFEGUARD APL 363 measures an air temperature by interworking with the thermometer application in the UE 3 (and any associated thermal sensor, if applicable).
#If Vital information is requested (e.g., the Requested information includes Vital information), the LIFEGUARD APL 363 obtains appropriate vital information and/or accesses any recorded vital information in the UE 3 by interworking with the health monitoring application in the UE 3 (and any associated sensor, if applicable).
#If Contact information is requested (e.g., the Requested information includes Contact information), the LIFEGUARD APL 363 provides a telephone number of the user of the UE 3 or a pre-set telephone number (e.g., the number of an emergency contact), relationship to the user of the UE 3 etc. For example, the contact information to return can be a family member's telephone number of the user of the UE 3 (e.g., the telephone number of a spouse or parent) and current residence address.

In one example, the LIFEGUARD APL 363 obtains at least some (or all) contact information stored in the UE 3 by interworking with an address book application in the UE 3.

Step 7. The LIFEGUARD APL 363 sends a SIP message including any collected data to the IMS (e.g., CSCF) 201. The collected data comprises data collected in step 6. The collected data may be included in SDP.

Step 8. The IMS (e.g., CSCF) 201 forwards the SIP message received in step 7 to the PSAP 202. Upon reception of the SIP message, the PSAP 202 may store the received SDP to the DATA STORAGE of the PSAP 202.

After step 8, the lifeguard agent refers to the collected data to take appropriate rescue actions. For example, in a case where the PSAP 202 stores the received SDP, the PSAP 202 may notify, to the life guard agent (e.g., a UE of the lifeguard agent) that the PSAP 202 has the collected data. Then the lifeguard agent may collect and refer data in the DATA STORAGE in the PSAP 202.

### (Second Example of the Second Aspect)

A Second example of the Second Aspect discloses a search procedure using a NEF as defined in 3GPP TS 23.501 (NPL 12) and 3GPP TS 23.502 (NPL 13). The search procedure is particularly useful for obtaining information regarding a user's location and situation in case that the user is known or deemed to be in an emergency situation.

A PSAP 202 comprises the following functions.
Warning message handling function: In order to support the search function, the PSAP 202 generates the warning message and sends it to the NEF 77. The PSAP 202 also receives the collected data from the NEF 77.

A LIFEGUARD APL 363 in the UE 3 comprises the following functions.
Warning message handling function: When a page (a paging message, system broadcast, and/or the like) including a warning indication is received, the LIFEGUARD APL 363 digests the received message and takes an appropriate action based on a request in the received message.

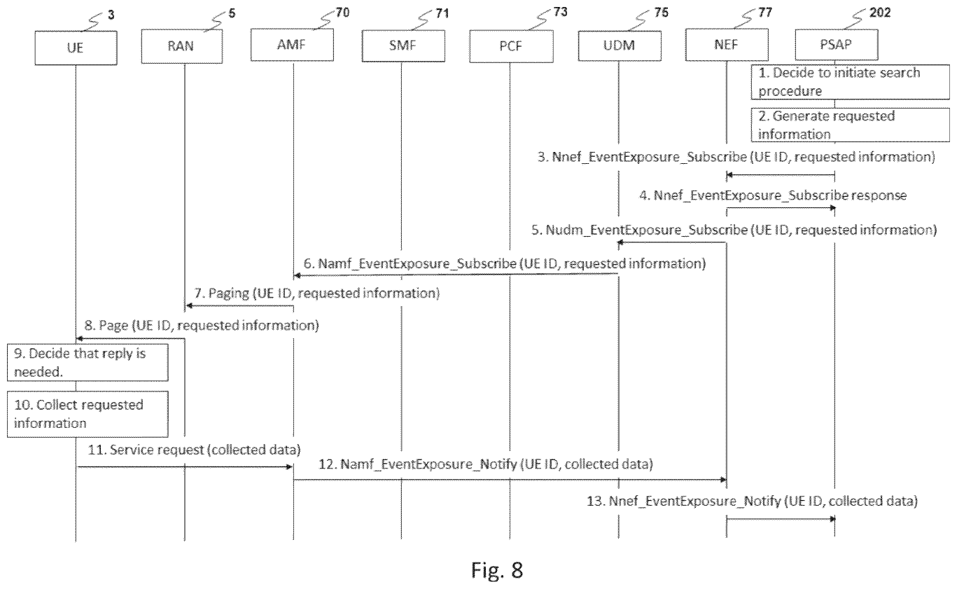

The detailed processes of the Second example of the Second Aspect are described below with reference to FIG. 8. FIG. 8 shows a person finding procedure using a NEF.

Step 1. The PSAP 202 decides to initiate the search procedure to find a user of the UE 3 who may be in emergency. For example, the worker in the PSAP 202 decides to initiate the search procedure to find a user of the UE 3 who may be in emergency. For example, the PSAP 202 may decide to initiate the search procedure in a case where the worker instructs the PSAP 202 to initiate the search procedure. For example, the worker may decide to initiate the search procedure and instruct the PSAP 202 to initiate the search procedure. The worker may decide to initiate the search procedure in a case where the worker makes (initiates) a call to the UE but there is no answer or reaction to the call from the user.

Step 2. The PSAP 202 generates a NEF service message including a Requested information. The contents of the Requested information can be the same as the Requested information that is described in step 2 of FIG. 4.

Step 3. The PSAP 202 sends an Nnef_EventExposure_Subscribe message including UE ID and the Requested information to a NEF 77. The UE ID may be any suitable identifier associated with the user or the UE 3 such as an IMSI, SUPI, PEI, or MSISDN number of the UE 3. If the UE ID is PEI or MSISDN number, the NEF 77 converts it to the SUPI of the UE 3.

Step 4. The NEF 77 sends an Nnef_EventExposure_Subscribe response message to the PSAP 202.

Step 5. The NEF 77 sends an Nudm_EventExposure_Subscribe message including the UE ID and the Requested information to a UDM 75. The UE ID may be IMSI or SUPI.

Step 6. The UDM 75 sends an Namf_EventExposure_Subscribe message including the UE ID and the Requested information to an AMF 70. The UE ID may be IMSI or SUPI.

Step 7. The AMF 70 sends a paging message including the UE ID and the Requested information to all RAN nodes 5 that are in a TAI list of the UE 3.

Step 8. The RAN node 5 receives the paging message from the AMF 70. The RAN node 5 pages the UE 3 with the Requested information. For example, the RAN node 5 may page the UE 3 with the UE ID and the Requested information.

Step 9. Upon reception of the paging message, the COMMUNICATIONS CONTROL MODULE 362 in the UE 3 recognizes the Requested information and signals to the LIFEGUARD APL 363 for notifying the received message (e.g., the Requested information). The LIFEGUARD APL 363 in the UE 3 analyzes the received message (e.g., the Requested information) and may decide to either ignore this message or perform the reporting procedure. For example, the LIFEGUARD APL 363 may decide to perform the reporting procedure based on the information included in the received message. For example, the LIFEGUARD APL 363 may decide to perform the reporting procedure in a case where the paging message includes the Requested information. In a case where the LIFEGUARD APL 363 decides to perform the reporting procedure, the LIFEGUARD APL 363 may perform a process in steps 10 and 11 described below, as the reporting procedure. For example, the LIFEGUARD APL 363 may decide to ignore the paging message in a case where the paging message does not include the requested information.

In addition, regardless of the decision above, the LIFEGUARD APL 363 may take one or more of the following actions:
Based on the received Notification mode, the LIFEGUARD APL 363 may make a warning beeping, play an alerting sound or vibrate the UE 3 to notify/alert the user of the UE 3.
If the warning message is received, the received message is displayed on a user display of the UE 3 or read out by a voice generation application in the UE 3.

Step 10. Step 10 is the same as the step 6 in FIG. 7.

Step 11. The UE 3 sends a Service request message to the AMF 70 including collected data. The collected data comprises any data collected in step 10.

Step 12. The AMF 70 sends an Namf_EventExposure_Notify message including the UE ID and the collected data to the NEF 77. The UE ID in the Namf_EventExposure_Notify message may be the same as the UE ID received in step 6.

Step 13. The NEF 77 sends an Nnef_EventExposure_Notify message including the UE ID and the collected data to the PSAP 202.

After step 13, the lifeguard agent refers to the collected data to take appropriate rescue actions. For example, in a case where the PSAP 202 stores the received SDP, the PSAP 202 may notify the life guard agent (e.g., a UE of the lifeguard agent) that the PSAP 202 has the collected data. Then the lifeguard agent may collect and refer to the data in the DATA STORAGE in the PSAP 202.

### (Third Example of the Second Aspect)

Third example of the Second Aspect discloses a search procedure using the NEF and PCF as defined in 3GPP TS 23.501 (NPL 12), 3GPP TS 23.502 (NPL 13) and TS 23.503 (NPL 14). The search procedure is particularly useful for obtaining information regarding a user's location and situation in case that the user is known or deemed to be in an emergency situation.

A PSAP 202 comprises the following functions.
Warning message handling function: In order to support the search function, the PSAP 202 generates a warning message and sends it to the NEF 77. The PSAP 202 also receives the collected data from the NEF 77.

A LIFEGUARD APL 363 in the UE 3 comprises the following functions.
Warning message handling function: When a page (a paging message, system broadcast, and/or the like) including a warning indication is received, the LIFEGUARD APL 363 digests the received message and takes an appropriate action based on a request in the received message.

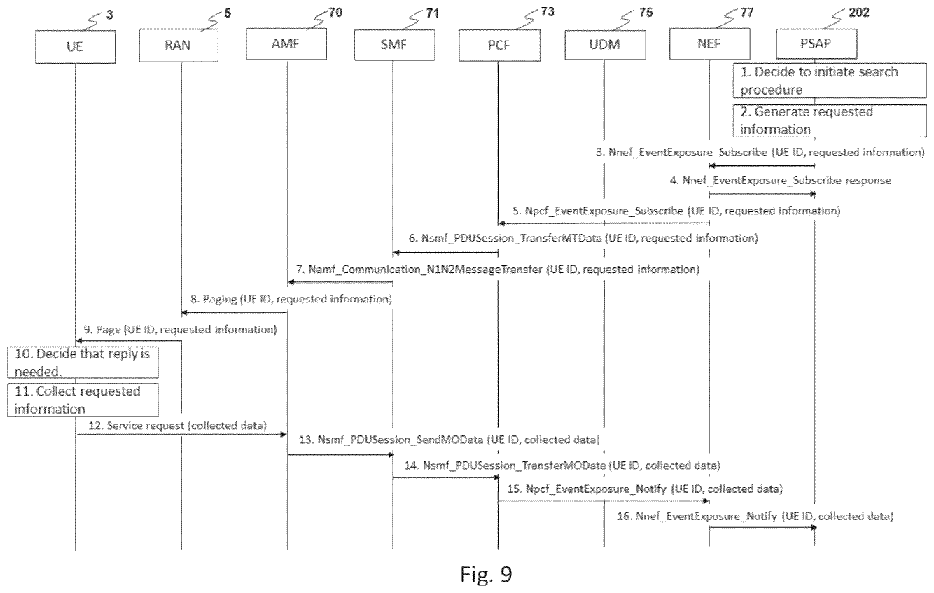

The detailed processes of the Second example of the Second Aspect are described below with reference to FIG. 9. FIG. 9 shows a person finding procedure using a NEF and a PCF.

Steps 1-4. Steps 1 to 4 are the same as steps 1 to 4 in FIG. 8.

Step 5. The NEF 77 sends an Npcf_EventExposure_Subscribe message including the UE ID and the Requested information to a PCF 73. The UE ID may be IMSI or SUPI.

If the UE 3 is roamed out to another PLMN than the home PLMN, then the PCF 73 may be split into two parts, H-PCF (home) and V-PCF (visited). In this case, the H-PCF forwards the received message in step 5 to the V-PCF using an Npcf_EventExposure_Subscribe message.

Step 6. The PCF 73 sends an Nsmf_PDUSession_TransferMTData message including the UE ID and the Requested information to an SMF 71. The UE ID may be IMSI or SUPI. For example, in a case where the V-PCF receives the Npcf_EventExposure_Subscribe message in step 5, the V-PCF may send the Nsmf_PDUSession_TransferMTData message to the SMF 71.

Step 7. The SMF 71 sends an Namf_Communication_NIN2MessageTransfer message including the UE ID and the Requested information to the AMF 70. The UE ID may be IMSI or SUPI.

Steps 8-12. Steps 8 to 12 are the same as steps 7 to 11 in FIG. 8.

Step 13: The AMF 70 sends an Nsmf_PDUSession_SendMOData message including the UE ID and the collected data to the SMF 71.

Step 14: The SMF 71 sends an Nsmf_PDUSession_TransferMOData message including the UE ID and the collected data to the PCF 73. If the UE 3 is roamed out to other PLMN, then the PCF 73 may be split into two parts, H-PCF and V-PCF. In this case, the V-PCF forwards the received message in step 14 to the H-PCF using an Npcf_EventExposure_Notify message.

Step 15: The PCF 73 sends an Npcf_EventExposure_Notify message including the UE ID and the collected data to the NEF 77. For example, in a case where the H-PCF receives the Nsmf_PDUSession_TransferMOData message in step 14, the H-PCF may send the Npcf_EventExposure_Notify message to the NEF 77.

Step 16: Step 16 is the same as the step 13 of FIG. 8.

After step 16, the lifeguard agent refers to the collected data to take appropriate rescue actions. For example, in a case where the PSAP 202 stores the received SDP, the PSAP 202 may notify the life guard agent (e.g., a UE of the lifeguard agent) that the PSAP 202 has the collected data. Then the lifeguard agent may collect and refer to the data in the DATA STORAGE in the PSAP 202.

### (Third Aspect)

This aspect discloses some examples of the UE behavior when a UE 3 receives a message from a network requesting to collect data due to emergency. According to this aspect, the UE 3 provides information indicating whether a user of the UE 3 is safe or not. The information indicating whether a user of the UE 3 is safe or not may be utilized by the lifeguard agent or the worker who uses the PSAP 202 to rescue the user or to decide the way for rescuing the user.

This aspect is commonly applicable to both the First aspect and the Second aspect when the UE 3 receives a message in one or more of the following situations:
When the UE 3 receives the broadcasted message at step 4 in FIG. 4.
When the UE receives the SIP message at step 11-1 in FIG. 5.
When the UE 3 receives the broadcasted message at step 4 in FIG. 6.
When the UE 3 receives the SIP INVITE message at step 4 in FIG. 7.
When the UE 3 receives the paging message with the Requested information at step 8 in FIG. 8.
When the UE 3 receives the paging message with the Requested information at step 9 in FIG. 9.

### (First Example of the Third Aspect)

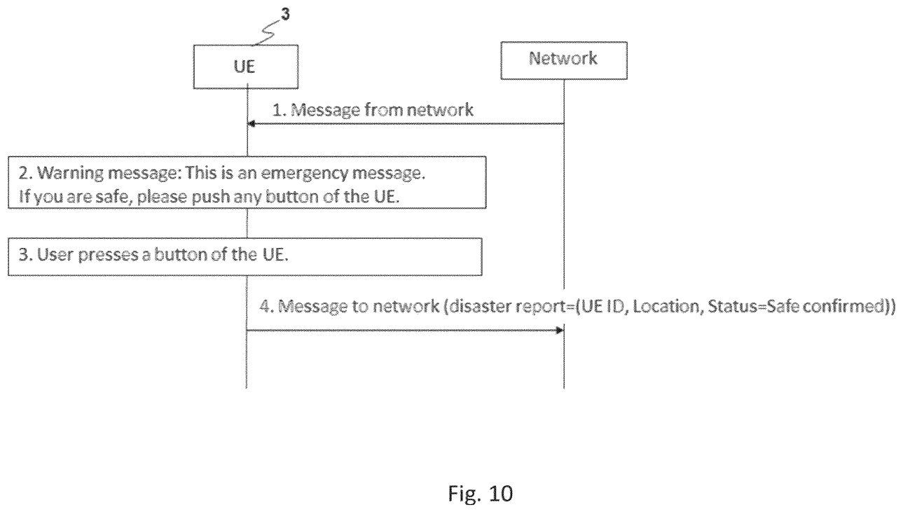

A First example of the Third Aspect discloses a UE behavior when the user of the UE 3 is safe. The Network in FIG. 10 may be a RAN node 5, an AMF 70, and/or an IMS 201. FIG. 10 shows UE behavior when the user of the UE 3 is safe.

The detailed processes of the First example of the Third Aspect are described below with reference to FIG. 10.

Step 1. The UE 3 receives a message indicating an emergency with the Requested information. The message in step 1 may be the broadcasted message described above with reference to step 4 of FIG. 4, the SIP message at step 11-1 of FIG. 5, the broadcasted message at step 4 of FIG. 6, the SIP INVITE message at step 4 of FIG. 7, the paging message with the Requested information at step 8 of FIG. 8, or the paging message with the Requested information at step 9 of FIG. 9.

Step 2. Upon reception of the message in step 1, the UE 3 makes a loud warning alert and/or performs an audible announcement that “This is an emergency message. If you are safe, please push any button of the UE” using voice generation application in the UE 3.

Step 3. The user of the UE 3 presses a button of the UE 3 (if the user thinks that he/she is safe).

Step 4. The UE 3 sends a message to the network including an appropriate UE ID of the UE 3, UE location indicating a location of the UE 3, and Status which is set to “Safe confirmed” (and/or the like). The Status which is set to “Safe confirmed” may indicate that the user of the UE 3 is safe. The UE ID, the UE location, and the Status may be included in an appropriate information element (e.g., a disaster report information element and/or the like) of the message transmitted in step 4.

For example, the UE 3 may obtain the UE ID (e.g., IMSI, SUPI or MSISDN number of the UE 3) from the memory of the UE 3.

For example, the UE 3 may obtain the UE location by interworking with the GPS application in the UE 3.

For example, the UE 3 may send the message in a case where the UE 3 detects that the user of the UE 3 presses a button of the UE 3 indicating that the user thinks that he/she is safe.

For example, in a case where the network is the RAN node 5, the UE 3 may send the message in step 4 of FIG. 10 to the RAN node 5. The information included in the message in step 4 of FIG. 10 may be sent in the message as shown in step 9 of FIG. 4. The information included in the message in step 4 of FIG. 10 may be sent in the message as shown in step 11-3 of FIG. 5. The information included in the message in step 4 of FIG. 10 may be sent with the collected data as shown in step 8 of FIG. 6.

For example, in a case where the network is the IMS 201, the IMS 201 may forward the message received in step 4 to the PSAP 202. The information included in the message in step 4 of FIG. 10 may be sent in the message as shown in step 7 of FIG. 7.

For example, in a case where the network is the AMF 70, the AMF 70 may forward the message received in step 4 to the PSAP 202 via the NEF 77 as shown in FIG. 8. The information included in the message in step 4 of FIG. 10 may be sent in the message as shown in step 11 of FIG. 8.

For example, in a case where the network is the AMF 70, the AMF 70 may forward the message received in step 4 to the PSAP 202 via the SMF 71, the PCF 73 and the NEF 77 as shown in FIG. 9. The information included in the message in step 4 of FIG. 10 may be sent in the message as shown in step 12 of FIG. 9.

### (Second Example of the Third Aspect)

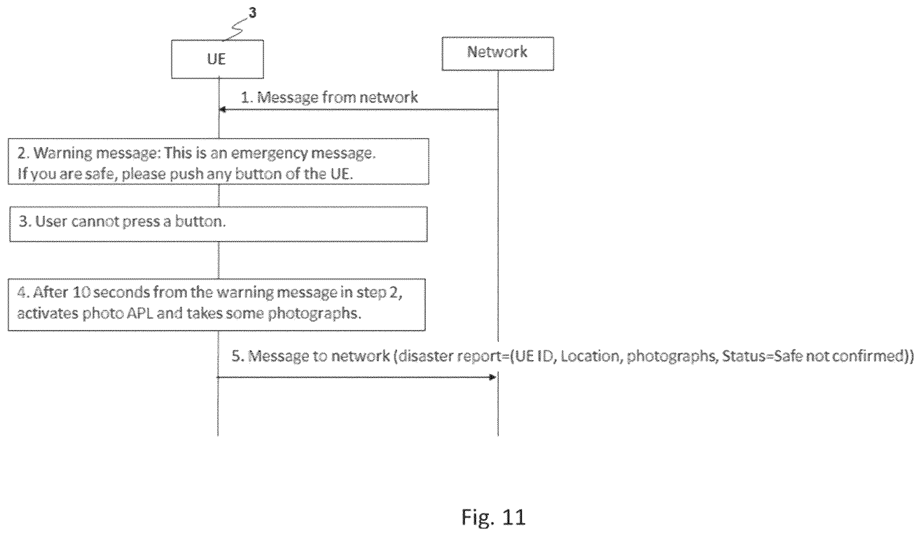

A Second example of the Third Aspect discloses a UE behavior when the user of the UE 3 is unconscious or unable to interact with the UE 3 for any other reason. The Network in FIG. 11 may be a RAN node 5, an AMF 70, and/or an IMS 201. FIG. 11 shows UE behavior when the user of the UE 3 is unconscious.

The detailed processes of the Second example of the Third Aspect are described below with reference to FIG. 11.

Step 1. The UE 3 receives a message indicating an emergency with the Requested information. Step 1 may be the same as step 1 of FIG. 10.

Step 2. Upon reception of the message in step 1, the UE 3 makes a loud warning alert and/or performs an audible announcement that “This is an emergency message. If you are safe, please push any button of the UE” using voice generation application in the UE 3.

Step 3. The user of the UE 3 cannot press a button of the UE 3 (e.g., because the user is unconscious).

Step 4. After the warning process in step 2 (e.g., after 10 seconds from the warning process in step 2), the UE 3 activates a photo APL (application) in the UE 3 and takes some photographs.

Step 5. The UE 3 sends a message to the network including a UE ID of the UE 3, UE location indicating a location of the UE 3, the photographs, and Status which is set to “Safe not confirmed”. The Status which is set to “Safe not confirmed” may indicate that the user of the UE 3 may be unconscious or may not be safe. The UE ID, the UE location, the photographs, and the Status may be included in an appropriate information element (e.g., a disaster report information element and/or the like) of the message transmitted in step 5.

For example, in a case where the network is the RAN node 5, the UE 3 may send the message in step 5 of FIG. 11 to the RAN node 5. The information included in the message in step 5 of FIG. 11 may be sent in the message as shown in step 9 of FIG. 4. The information included in the message in step 5 of FIG. 11 may be sent in the message as shown in step 11-3 of FIG. 5. The information included in the message in step 5 of FIG. 11 may be sent with the collected data as shown in step 8 of FIG. 6.

For example, in a case where the network is the IMS 201, the IMS 201 may forward the message received in step 4 to the PSAP 202. The information included in the message in step 5 of FIG. 11 may be sent in the message as shown in step 7 of FIG. 7.

For example, in a case where the network is the AMF 70, the AMF 70 may forward the message received in step 4 to the PSAP 202 via the NEF 77 as shown in FIG. 8. The information included in the message in step 5 of FIG. 11 may be sent in the message as shown in step 11 of FIG. 8.

For example, in a case where the network is the AMF 70, the AMF 70 may forward the message received in step 4 to the PSAP 202 via the SMF 71, the PCF 73 and the NEF 77 as shown in FIG. 9. The information included in the message in step 5 of FIG. 11 may be sent in the message as shown in step 12 of FIG. 9.

### (Third Example of the Third Aspect)

A Third example of the Third Aspect discloses a UE behavior when the user of the UE 3 is unconscious or unable to interact with the UE 3 for any other reason. In this example, the UE 3 has an appropriate health measurement function. For example, the UE 3 may be a smart watch UE or connected to a smart watch worn by the user.

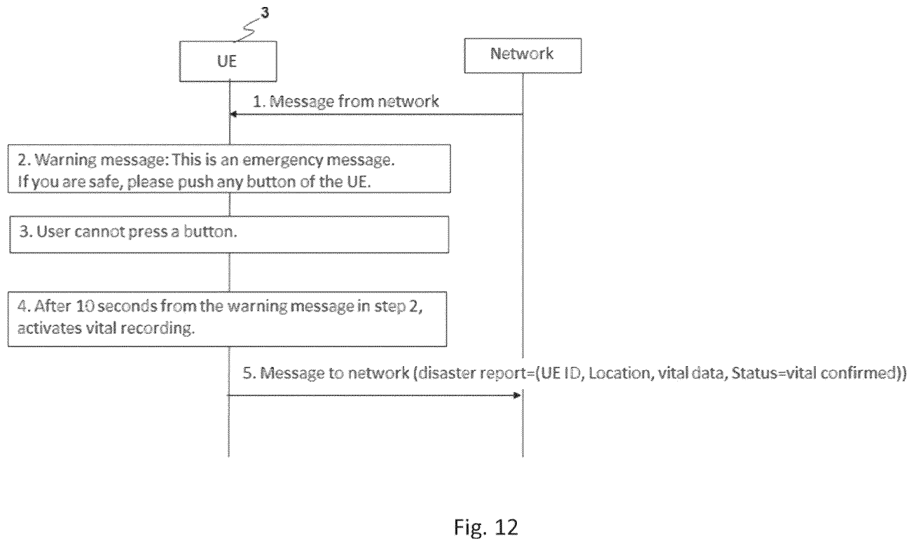

The Network in FIG. 12 may be a RAN node 5, an AMF 70, and/or an IMS 201. FIG. 12 shows UE behavior when the user of the UE 3 is unconscious with health measurement function equipped.

The detailed processes of the Third example of the Third Aspect are described below with reference to FIG. 12.

Step 1. The UE 3 receives a message indicating an emergency with the Requested information. Step 1 may be the same as step 1 of FIG. 10.

Step 2. Upon reception of the message in step 1, the UE 3 makes a loud warning alert and/or performs an audible announcement that “This is an emergency message. If you are safe, please push any button of the UE” using voice generation application in the UE 3.

Step 3. The user of the UE 3 cannot press a button of the UE 3 (e.g., because the user is unconscious).

Step 4. After the warning process in step 2 (e.g., after 10 seconds from the warning process in step 2), the UE 3 performs vital measurements to obtain vital data of a user of the UE. The vital data that is measured previously in the memory of the UE 3 may also be obtained.

Step 5. The UE 3 sends a message to the network including the UE ID of the UE 3, UE location indicating location of the UE 3, the vital data obtained in step 4, and Status which is set to “Vital confirmed”. The Status which is set to “Vital confirmed” may also indicate that the vital data has been confirmed by the user. The Status which is set to “Vital confirmed” may also indicate that the vital data has been confirmed. The UE ID, the UE location, the vital data, and the Status may be included in an appropriate information element (e.g., a disaster report information element and/or the like) of the message transmitted in step 5.

For example, in a case where the network is the RAN node 5, the UE 3 may send the message in step 5 of FIG. 12 to the RAN node 5. The information included in the message in step 5 of FIG. 12 may be sent in the message as shown in step 9 of FIG. 4. The information included in the message in step 5 of FIG. 12 may be sent in the message as shown in step 11-3 of FIG. 5. The information included in the message in step 5 of FIG. 12 may be sent with the collected data as shown in step 8 of FIG. 6.

For example, in a case where the network is the IMS 201, the IMS 201 may forward the message received in step 4 to the PSAP 202. The information included in the message in step 5 of FIG. 12 may be sent in the message as shown in step 7 of FIG. 7.

For example, in a case where the network is the AMF 70, the AMF 70 may forward the message received in step 4 to the PSAP 202 via the NEF 77 as shown in FIG. 8. The information included in the message in step 5 of FIG. 12 may be sent in the message as shown in step 11 of FIG. 8.

For example, in a case where the network is the AMF 70, the AMF 70 may forward the message received in step 4 to the PSAP 202 via the SMF 71, the PCF 73 and the NEF 77 as shown in FIG. 9. The information included in the message in step 5 of FIG. 12 may be sent in the message as shown in step 12 of FIG. 9.

### (System Overview)

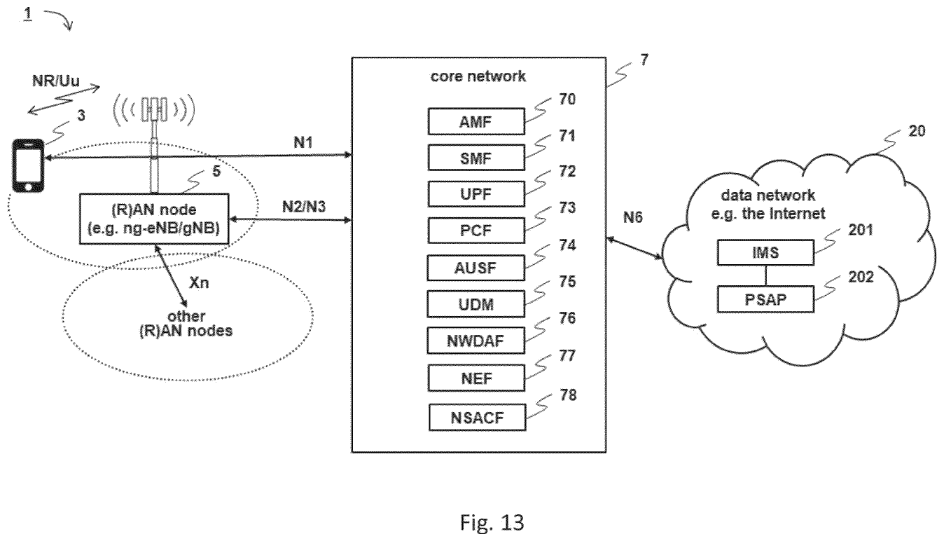

FIG. 13 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may be split into one or more Radio Unit (RU), one or more Distributed Unit (DU), and one or more Centralized Unit (CU). In some aspects, each of the units may be connected to each other and form the (R)AN node 5 by adopting an architecture as defined by the Open RAN (O-RAN) Alliance, where the units above are referred to are O-RU, O-DU, and O-CU respectively.

The (R)AN node 5 may be split into a control plane function and a user plane function. Further, multiple user plane functions can be allocated to support a communication. In some aspects, user traffic may be distributed to multiple user plane functions and user traffic over each user plane functions may be aggregated in both the UE 3 and the (R)AN node 5. This split architecture may be called as ‘dual connectivity’ or ‘Multi connectivity’.

The (R)AN node 5 may also support communications using the satellite access. In some aspects, the (R)AN node 5 may support at least one of a satellite access and a terrestrial access. Satellite access may also be referred to as non-terrestrial access.

In addition, the (R)AN node 5 may also be referred to as an access node for a non-wireless access. Such non-wireless access may include for example a fixed line access as defined by the Broadband Forum (BBF) and/or an optical access as defined by the Innovative Optical and Wireless Network (IOWN).

The core network 7 may include logical nodes (or ‘functions’) for supporting communication in the telecommunication system 1. For example, the core network 7 may be a 5G Core Network (5GC) that includes, amongst other functions, control plane functions and user plane functions. Each function in a logical nodes may be considered as a network function. The network function may be provided to another node by adapting the Service Based Architecture (SBA).

A Network Function may be deployed as a distributed, redundant, stateless, and scalable function that provides the services from several locations and several execution instances in each location by adapting the network virtualization technology as defined by the European Telecommunications Standards Institute, Network Functions Virtualization (ETSI NFV).

The core network 7 may support the so-called Non-Public Network (NPN) functionality. The NPN may be a Stand-alone Non-Public Network (SNPN) or a Public Network Integrated NPN (PNI-NPN).

As is well known, a UE 3 may enter and leave the areas (i.e., radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

In this example, for sake of illustration, the core network 7 also includes, amongst others, a Session Management Function (SMF) 71, a User Plane Function (UPF) 72, a Policy Control Function (PCF) 73, an Authentication Server Function (AUSF) 74, a Unified Data Management (UDM) 75, a Network Data Analytics Function (NWDAF) 76, a Network Exposure Function (NEF) 77, and a Network Slice Admission Control Function (NSACF) 78. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN nodes 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 may connect to the data network 20 using IPV4, IPV6, IPv4v6, Ethernet, or unstructured data type. The data network 20 may include the above described IMS 201 and PSAP 202 nodes.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible for establishing, modifying, and releasing a connection between the UE 3 and a serving (R)AN node 5. The Control plane of Uu interface may have a layered structure with RRC, PDCP, RLC and MAC sublayers over the physical connection.

For example, the following messages may be communicated over the RRC layer to support AS signalling:
RRC Setup Request message: This message is sent from the UE 3 to the (R)AN node 5. In addition to the parameters that are disclosed by the Aspects described in this disclosure, the following parameters may be included together in the RRC Setup Request message:
#establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by the Aspects described in this disclosure, the following parameters may be included together in the RRC Setup message:
#masterCellGroup and radioBearerConfig
RRC setup complete message: This message is sent from the UE 3 to the (R)AN node 5. In addition to the parameters that are disclosed by the Aspects described in this disclosure, the following parameters may be included together in the RRC setup complete message:
#guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is for communicating between the UE 3 and the AMF 70 using NAS signalling. The N1 interface may be established over a 3GPP access and/or over a non-3GPP access. For example, the following messages may be communicated over the N1 interface:
registration request message: This message is sent from the UE 3 to the AMF 70. In addition to the parameters that are disclosed by the Aspects described in this disclosure, the following parameters may be included together in the registration request message:
#5GS registration type, ngKSI, 5GS mobile identity, Non-current native NAS key set identifier, 5GMM capability, UE security capability, Requested NSSAI, Last visited registered TAI, SI UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.

registration accept message: This message is sent from the AMF 70 to the UE 3. In addition to the parameters that are disclosed by the Aspects described in this disclosure, the following parameters may be included together in the registration accept message:
#5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by the Aspects described in this disclosure, the following parameters may be included together in the Registration Complete message:
#SOR transparent container.
Authentication Request message: This message is sent from the AMF 70 to the UE 3. In addition to the parameters that are disclosed by the Aspects described in this disclosure, the following parameters may be included together in the Authentication Request message:
#ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by the Aspects described in this disclosure, the following parameters may be populated together in the Authentication Response message:
#Authentication response message identity, Authentication response parameter and EAP message.
Authentication Result message: This message is sent from the AMF 70 to the UE 3. In addition to the parameters that are disclosed by the Aspects described in this disclosure, the following parameters may be populated together in the Authentication Result message:
#ngKSI, EAP message and ABBA.
Authentication Failure message: This message is sent from the UE 3 to the AMF 70. In addition to the parameters that are disclosed by the Aspects described in this disclosure, the following parameters may be populated together in the Authentication Failure message:
#Authentication failure message identity, 5GMM cause and Authentication failure parameter.
Authentication Reject message: This message is sent from the AMF 70 to the UE 3. In addition to the parameters that are disclosed by the Aspects described in this disclosure, the following parameters may be populated together in the Authentication Reject message:
#EAP message.
Service Request message: This message is sent from the UE 3 to the AMF 70. In addition to the parameters that are disclosed by the Aspects described in this disclosure, the following parameters may be populated together in the Service Request message:
#ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by the Aspects described in this disclosure, the following parameters may be populated together in the Service Accept message:
#PDU session status, PDU session reactivation result, PDU session reactivation result error cause, EAP message and T3448 value.
Service Reject message: This message is sent from the AMF 70 to the UE 3. In addition to the parameters that are disclosed by the Aspects described in this disclosure, the following parameters may be populated together in the Service Reject message:
#5GMM cause, PDU session status, T3346 value, EAP message, T3448 value and CAG information list.
Configuration Update Command message: This message is sent from the AMF 70 to the UE 3. In addition to the parameters that are disclosed by the Aspects described in this disclosure, the following parameters may be populated together in the Configuration Update Command message:
#Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by the Aspects described in this disclosure, the following parameters may be populated together in the Configuration Update Complete message:
#Configuration update complete message identity.

### (User Equipment (UE))

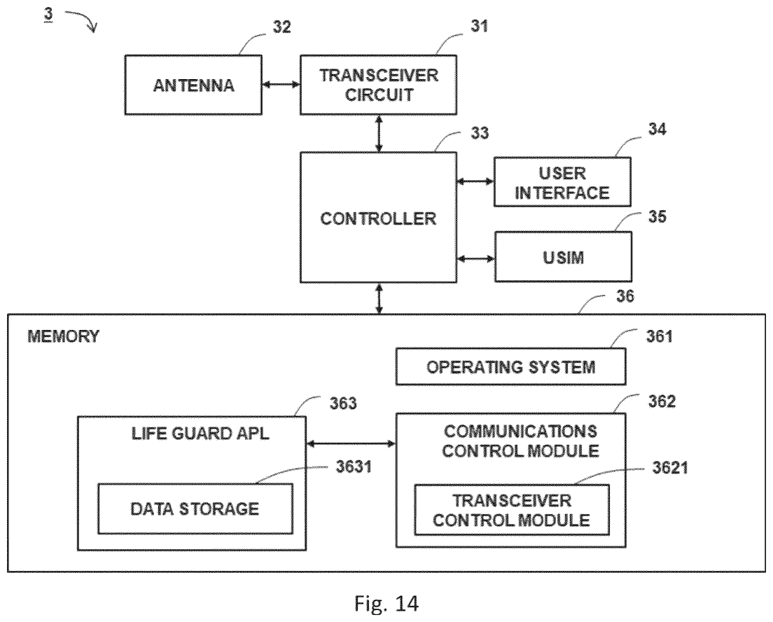

FIG. 14 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in FIG. 14, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g., a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The memory 36 may include the LIFE GUARD APL 363. The controller 33 may run the LIFE GUARD APL 363 to perform the processes of the UE 3 described in this disclosure.

The UE 3 may include an associated DATA STORAGE 3631. The memory 36 may include the DATA STORAGE 3631 (for example, as part of the LIFE GUARD APL 363).

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g., vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g., smart glasses, a smart watch, a smart ring, or a hearable device).

The UE 3 may be a car, or a connected car, or an autonomous car, or a vehicle device, or a motorcycle or V2X (Vehicle to Everything) communication module (e.g., Vehicle to Vehicle communication module, Vehicle to Infrastructure communication module, Vehicle to People communication module and Vehicle to Network communication module).

### ((R)an Node)

FIG. 15 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g., directly or indirectly). The signalling may include, for example, appropriately formatted signalling messages relating to a radio connection and a connection with the core network 7 (for a particular UE 3), and in particular, relating to connection establishment and maintenance (e.g., RRC connection establishment and other RRC messages), NG Application Protocol (NGAP) messages (i.e., messages by N2 reference point) and Xn application protocol (XnAP) messages (i.e., messages by Xn reference point), etc. Such signalling may also include, for example, broadcast information (e.g., Master Information and System information) in a sending case.

The controller 54 is also configured (by software or hardware) to handle related tasks such as, when implemented, UE mobility estimation and/or moving trajectory estimation.

The (R)AN node 5 may support the Non-Public Network (NPN), The NPN may be a Stand-alone Non-Public Network (SNPN) or a Public Network Integrated NPN (PNI-NPN).

The memory 55 may include the LIFE GUARD APL 553. The controller 54 may run the LIFE GUARD APL 553 to perform the processes of the RAN node 5 described in this disclosure.

The RAN node 5 may include a DATA STORAGE 5531. The memory 55 may include the DATA STORAGE 5531 (for example, as part of the LIFE GUARD APL 553).

### (System Overview of (R)AN Node 5 Based on O-RAN Architecture)

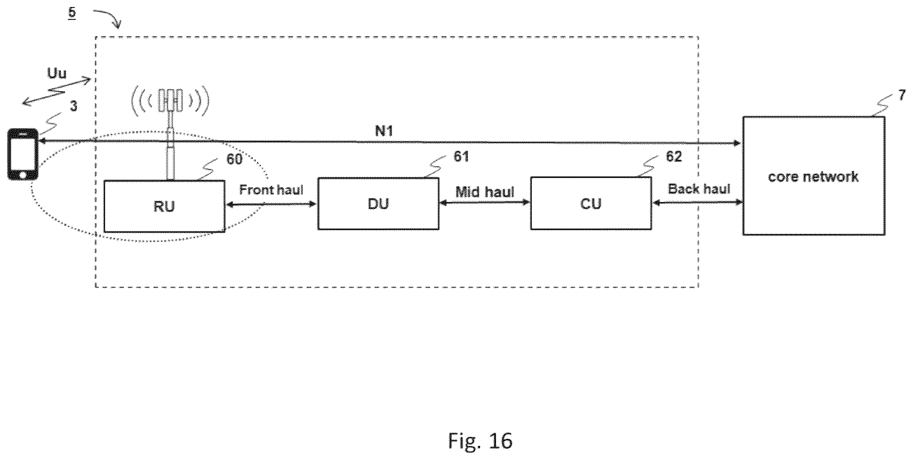

FIG. 16 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, a Distributed Unit (DU) 61, and a Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g., one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61, and CU 62, each unit provides some of the functionality that is provided by the (R)AN node 5. For example, the RU 60 may provide functionalities to communicate with a UE 3 over the air interface, the DU 61 may provide functionalities to support MAC layer and RLC layer, the CU 62 may provide functionalities to support PDCP layer, SDAP layer and RRC layer.

### (Radio Unit (RU))

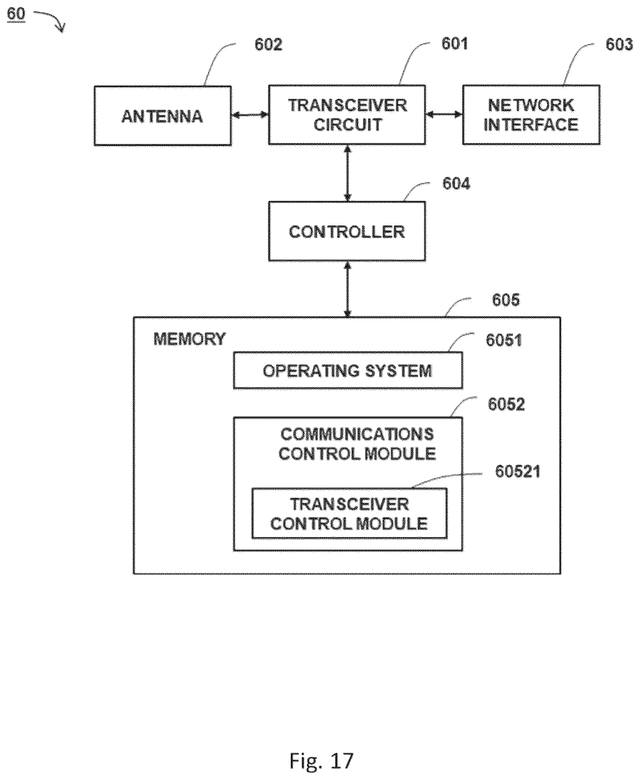

FIG. 17 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g., directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimation and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### (Distributed Unit (DU))

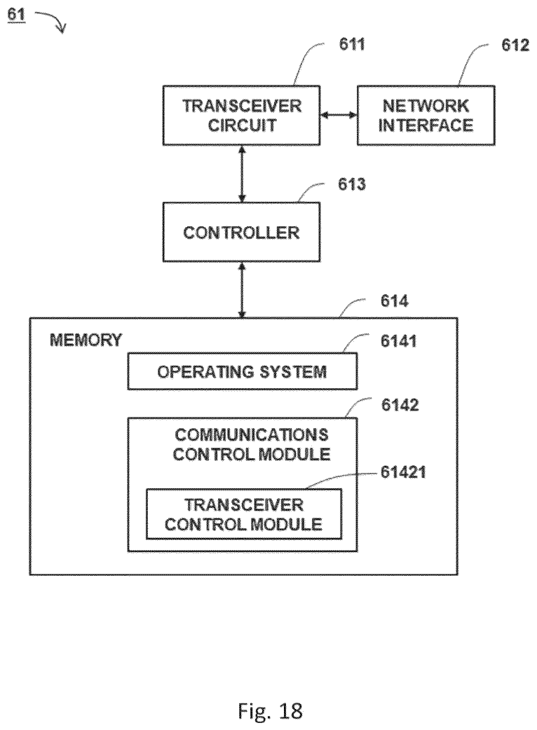

FIG. 18 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### (Centralized Unit (CU))

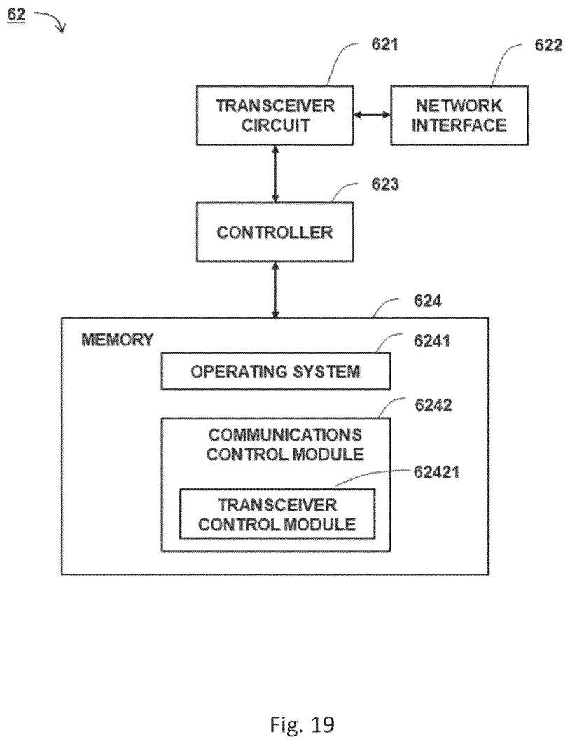

FIG. 19 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### (AMF)

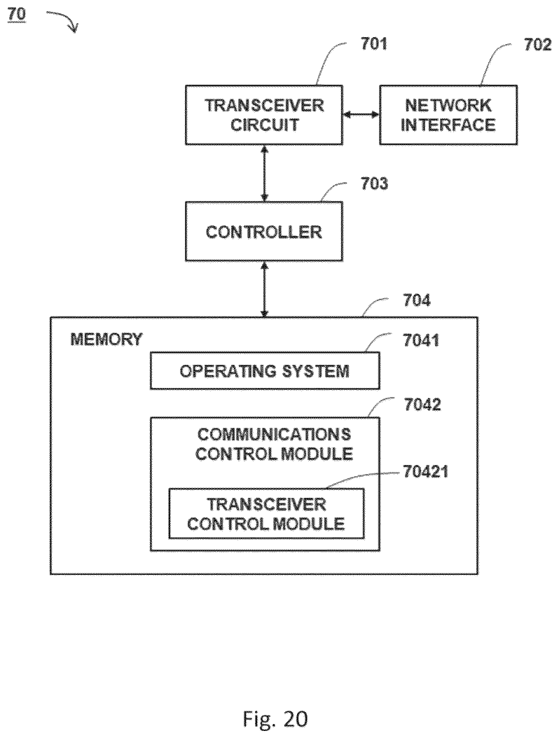

FIG. 20 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g., via the (R)AN node 5) and other core network nodes (including core network nodes in the HPLMN of the UE 3 when the UE 3 is roaming-in. Such signalling may include, for example, appropriately formatted signalling messages (e.g., a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### (SMF)

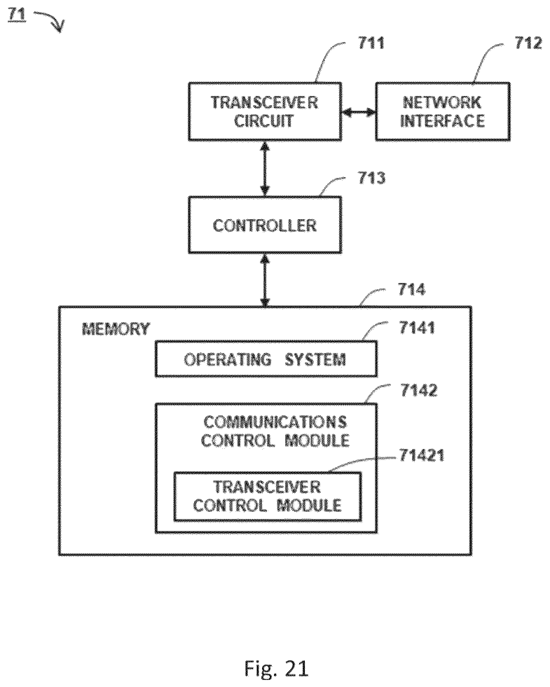

FIG. 21 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable data storage device (RMD), for example. The software includes, among other things, an operating system 7141 and a communications control module 7142 having at least a transceiver control module 71421. The communications control module 7142 (using its transceiver control module 71421) is responsible for handling (generating/sending/receiving) signalling between the SMF 71 and other nodes, such as the UPF 72 and other core network nodes (including core network nodes in the HPLMN of the UE 3 when the UE 3 is roaming-in). Such signalling may include, for example, appropriately formatted signalling messages (e.g., a Hypertext Transfer Protocol (HTTP) restful method based on the service based interfaces) relating to session management procedures (for the UE 3).

The SMF 71 may support the Non-Public Network (NPN), The NPN may be a Stand-alone Non-Public Network (SNPN) or a Public Network Integrated NPN (PNI-NPN).

### (UPF)

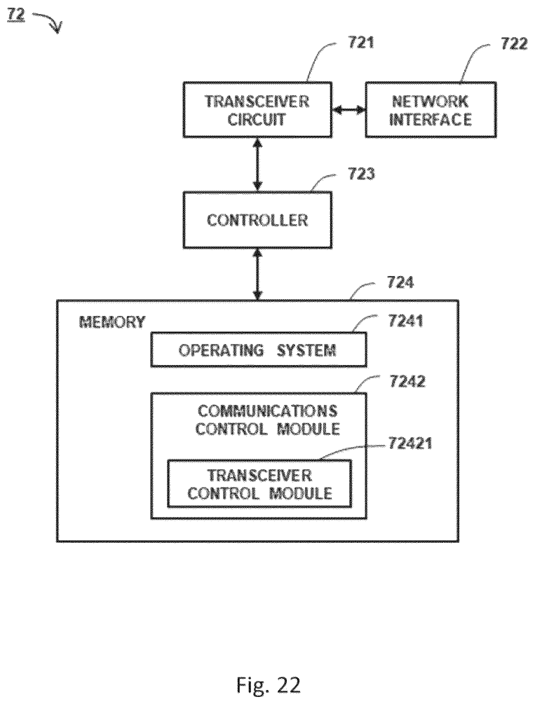

FIG. 22 is a block diagram illustrating the main components of the UPF 72. As shown, the apparatus includes a transceiver circuit 721 which is operable to transmit signals to and to receive signals from other nodes (including the SMF 71) via a network interface 722. A controller 723 controls the operation of the UPF 72 in accordance with software stored in a memory 724. Software may be pre-installed in the memory 724 and/or may be downloaded via the telecommunication network or from a removable data storage device (e.g. a removable memory device (RMD)), for example. The software includes, among other things, an operating system 7241 and a communications control module 7242 having at least a transceiver control module 72421. The communications control module 7242 (using its transceiver control module 72421 is responsible for handling (generating/sending/receiving) signalling between the UPF 72 and other nodes, such as the SMF 71 and other core network nodes (including core network nodes in the HPLMN of the UE 3 when the UE 3 is roaming-in. Such signalling may include, for example, appropriately formatted signalling messages (e.g., a GPRS Tunneling Protocol (GTP) for User plane) relating to User data handling (for the UE 3).

The UPF 72 may support the Non-Public Network (NPN), The NPN may be a Stand-alone Non-Public Network (SNPN) or a Public Network Integrated NPN (PNI-NPN).

The collocated gNB-CU-UP and UPF or the communication apparatus executing function of a collocated gNB-CU-UP and UPF or the communication apparatus executing function of the gNB-CU-UP and function of the UPF may have same components to the UPF 72.

### (PCF)

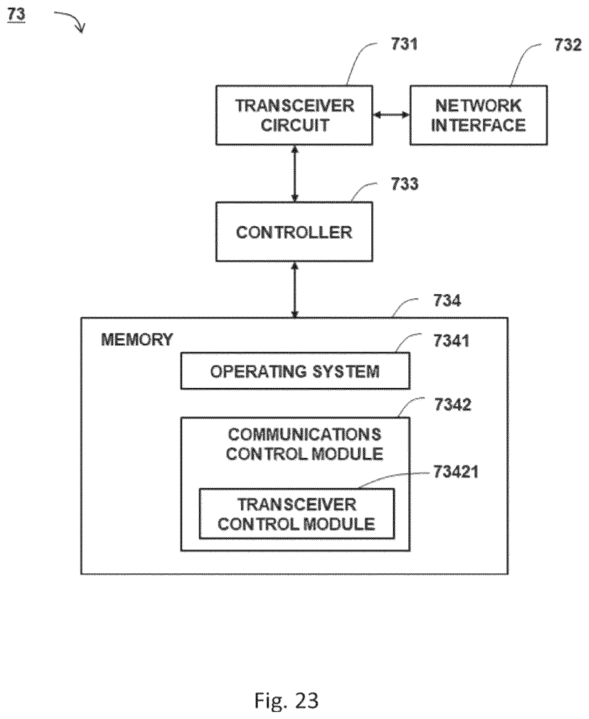

FIG. 23 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g., a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g., a HTTP restful method based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN). The H-PCF and the V-PCF may include the same components as the PCF 73.

### (AUSF)

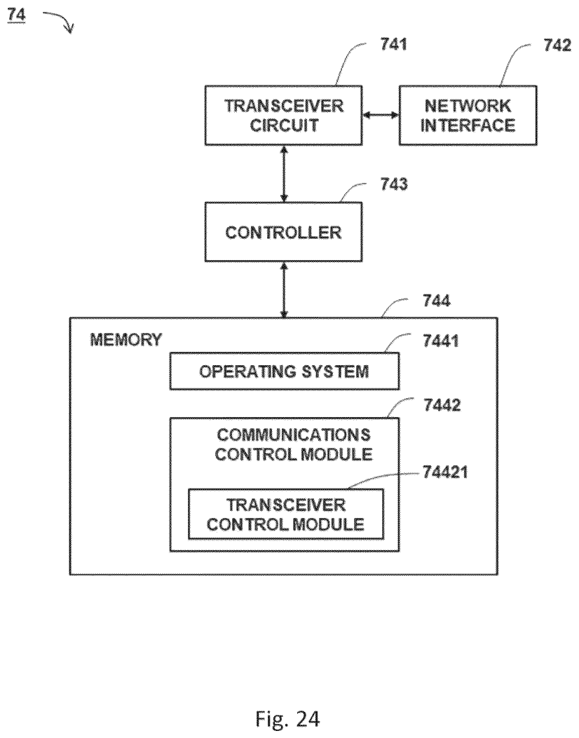

FIG. 24 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421) is responsible for handling (generating/sending/receiving) signalling between the AUSF 74 and other nodes, such as the AMF 70 and other core network nodes (including core network nodes in the HPLMN of the UE 3 when the UE 3 is roaming-in). Such signalling may include, for example, appropriately formatted signalling messages (e.g., a HTTP restful method based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PNI-NPN).

### (UDM)

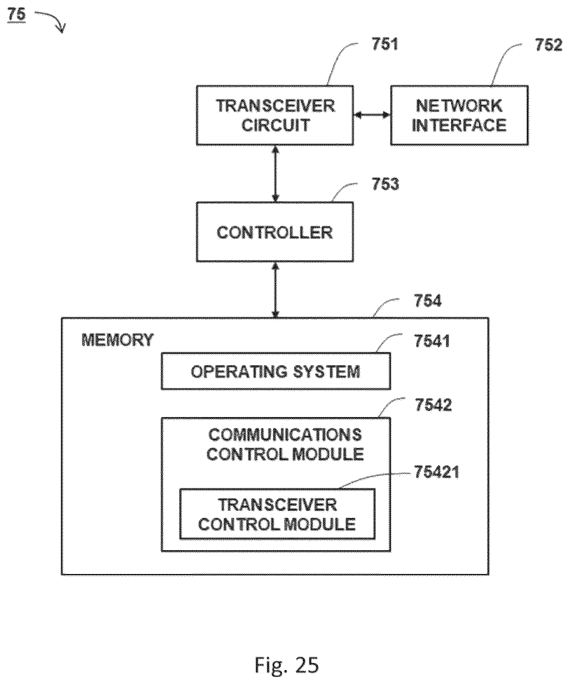

FIG. 25 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421) is responsible for handling (generating/sending/receiving) signalling between the UDM 75 and other nodes, such as the AMF 70 and other core network nodes (including core network nodes in the VPLMN of the UE 3 when the UE 3 is roaming-out). Such signalling may include, for example, appropriately formatted signalling messages (e.g., a HTTP restful method based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### (NWDAF)

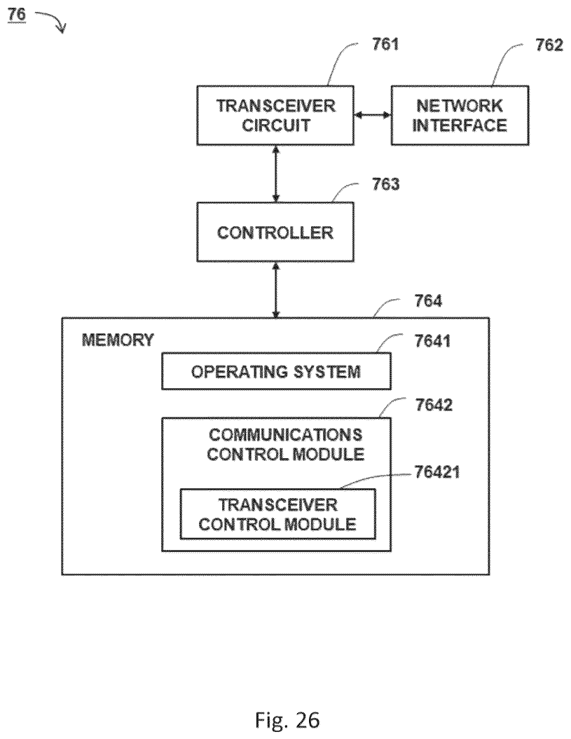

FIG. 26 is a block diagram illustrating the main components of the NWDAF 76. As shown, the apparatus includes a transceiver circuit 761 which is operable to transmit signals to and to receive signals from other nodes (including the AMF 70) via a network interface 762. A controller 763 controls the operation of the NWDAF 76 in accordance with the software stored in a memory 764. The Software may be pre-installed in the memory 764 and/or may be downloaded via the telecommunication network or from a removable data storage device (e.g., a removable memory device (RMD)), for example. The software includes, among other things, an operating system 7641 and a communications control module 7642 having at least a transceiver control module 76421. The communications control module 7642 (using its transceiver control module 76421) is responsible for handling (generating/sending/receiving) signalling between the NWDAF 76 and other nodes, such as the AMF 70 and other core network nodes (including core network nodes in the HPLMN of the UE 3 when the UE 3 is roaming-in). Such signalling may include, for example, appropriately formatted signalling messages (e.g., a HTTP restful method based on the service based interfaces) relating to network data analytics function procedures (for the UE 3).

The NWDAF 76 may support the Non-Public Network (NPN), The NPN may be a Stand-alone Non-Public Network (SNPN) or a Public Network Integrated NPN (PNI-NPN).

### (NEF)

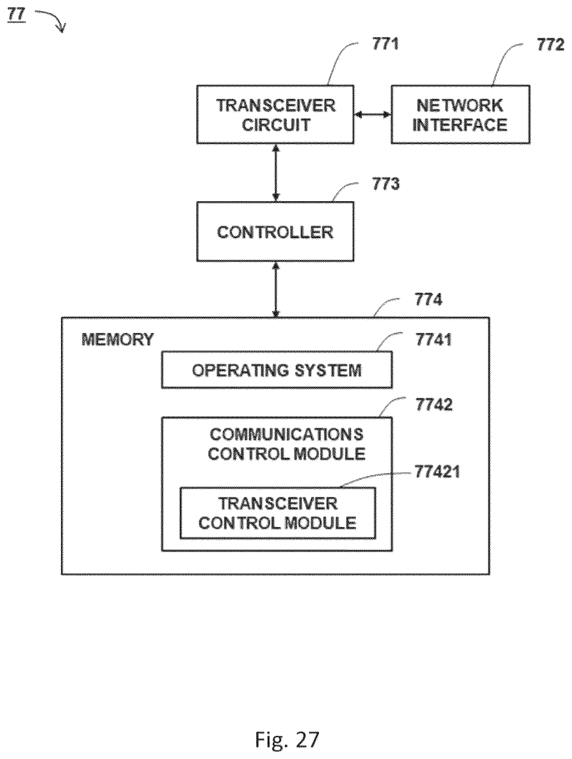

FIG. 27 is a block diagram illustrating the main components of the NEF 77. As shown, the apparatus includes a transceiver circuit 771 which is operable to transmit signals to and to receive signals from other nodes (including the UDM 75) via a network interface 772. A controller 773 controls the operation of the NEF 77 in accordance with software stored in a memory 774. Software may be pre-installed in the memory 774 and/or may be downloaded via the telecommunication network or from a removable data storage device (e.g. a removable memory device (RMD)), for example. The software includes, among other things, an operating system 7741 and a communications control module 7742 having at least a transceiver control module 77421. The communications control module 7742 (using its transceiver control module 77421) is responsible for handling (generating/sending/receiving) signalling between the NEF 77 and other nodes, such as the UDM 75 and other core network nodes (including core network nodes in the HPLMN of the UE 3 when the UE 3 is roaming-in). Such signalling may include, for example, appropriately formatted signalling messages (e.g., a HTTP restful method based on the service based interfaces) relating to network exposure function procedures (for the UE 3).

The NEF 77 may support the Non-Public Network (NPN), The NPN may be a Stand-alone Non-Public Network (SNPN) or a Public Network Integrated NPN (PNI-NPN).

### (NSACF)

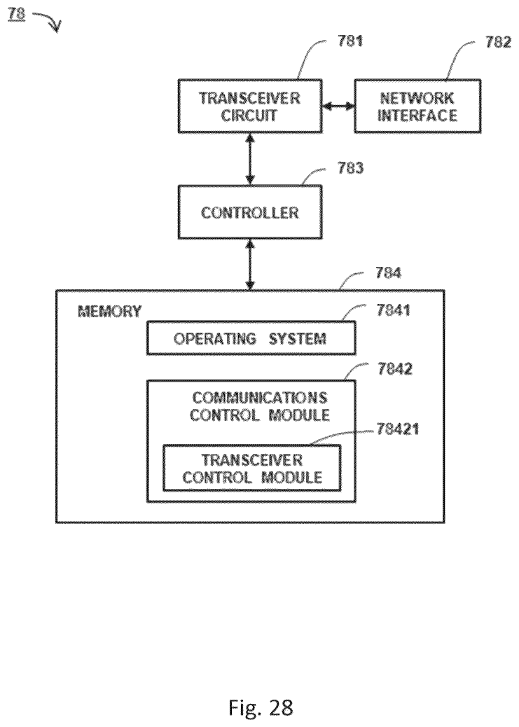

FIG. 28 is a block diagram illustrating the main components of the NSACF 78. As shown, the apparatus includes a transceiver circuit 781 which is operable to transmit signals to and to receive signals from other nodes (including the AMF 70) via a network interface 782. A controller 783 controls the operation of the NSACF 78 in accordance with the software stored in a memory 784. The Software may be pre-installed in the memory 784 and/or may be downloaded via the telecommunication network or from a removable data storage device (RMD), for example. The software includes, among other things, an operating system 7841 and a communications control module 7842 having at least a transceiver control module 78421. The communications control module 7842 (using its transceiver control module 78421) is responsible for handling (generating/sending/receiving) signalling between the NSACF 78 and other nodes, such as the AMF 70 and other core network nodes (including core network nodes in the HPLMN of the UE 3 when the UE 3 is roaming-in). Such signalling may include, for example, appropriately formatted signalling messages (e.g., a HTTP restful method based on the service based interfaces) relating to network data analytics function procedures (for the UE 3).

The NSACF 78 may support the Non-Public Network (NPN), The NPN may be a Stand-alone Non-Public Network (SNPN) or a Public Network Integrated NPN (PNI-NPN).

### (IMS)

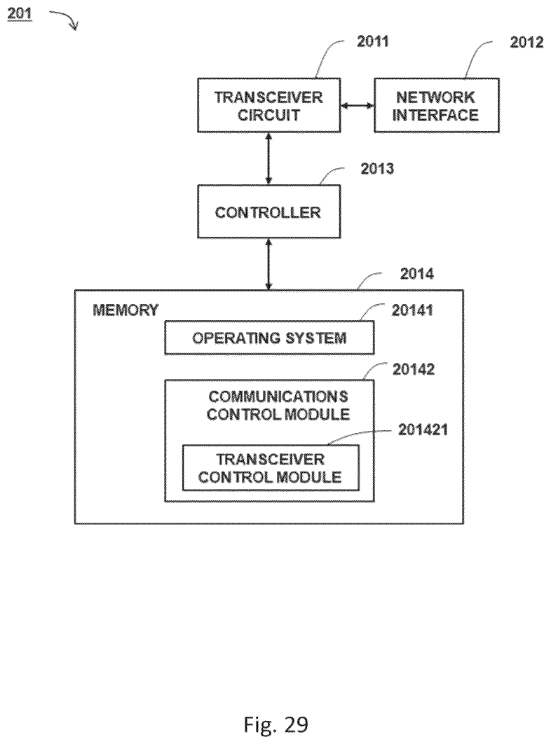

FIG. 29 is a block diagram illustrating the main components of the IMS 201. As shown, the apparatus includes a transceiver circuit 2011 which is operable to transmit signals to and to receive signals from other nodes (including the UE 3, the NEF 77, the PSAP 202) via a network interface 2012. A controller 2013 controls the operation of the IMS 201 in accordance with software stored in a memory 2014. Software may be pre-installed in the memory 2014 and/or may be downloaded via the telecommunication network or from a removable data storage device (RMD), for example. The software includes, among other things, an operating system 20141 and a communications control module 20142 having at least a transceiver control module 201421. The communications control module 20142 (using its transceiver control module 201421) is responsible for handling (generating/sending/receiving) signalling between the IMS 201 and other nodes, such as the UE 3, the NEF 77 or the PSAP 202 and other core network nodes (including core network nodes in the VPLMN of the UE 3 when the UE 3 is roaming-out). Such signalling may include, for example, appropriately formatted signalling messages (e.g., a HTTP restful method based on the service based interfaces) relating to mobility management procedures (for the UE 3).

The IMS 201 may support the Non-Public Network (NPN), The NPN may be a Stand-alone Non-Public Network (SNPN) or a Public Network Integrated NPN (PNI-NPN).

The IMS (CSCF) may include the same components as the IMS 201 described in the above Aspects.

### (PSAP)

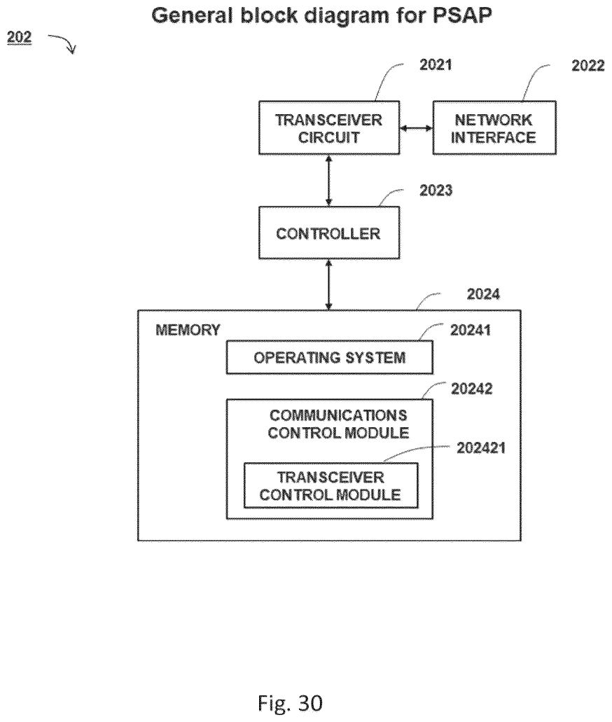

FIG. 30 is a block diagram illustrating the main components of the PSAP 202. As shown, the apparatus includes a transceiver circuit 2011 which is operable to transmit signals to and to receive signals from other nodes (including the NEF 77, the IMS 201) via a network interface 2012. A controller 2013 controls the operation of the PSAP 202 in accordance with software stored in a memory 2014. Software may be pre-installed in the memory 2014 and/or may be downloaded via the telecommunication network or from a removable data storage device (RMD), for example. The software includes, among other things, an operating system 20141 and a communications control module 20142 having at least a transceiver control module 201421. The communications control module 20142 (using its transceiver control module 201421) is responsible for handling (generating/sending/receiving) signalling between the PSAP 202 and other nodes, such as the NEF 77 or the IMS 201 and other core network nodes (including core network nodes in the VPLMN of the UE 3 when the UE 3 is roaming-out). Such signalling may include, for example, appropriately formatted signalling messages (e.g., a HTTP restful method based on the service based interfaces) relating to mobility management procedures (for the UE 3).

The PSAP 202 may support the Non-Public Network (NPN), The NPN may be a Stand-alone Non-Public Network (SNPN) or a Public Network Integrated NPN (PNI-NPN).

### (Modifications and Alternatives)

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g., WLAN, Wi-Fi, WiMAX, Bluetooth, etc.) and other fix line communications technology (e.g., BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and/or a system. Accordingly, the present disclosure may take the form of an entirely hardware embodiment, a software embodiment, or an embodiment combining software and hardware aspects.

It will be understood that each block of the block diagrams can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### (Supplementary Notes)

The whole or part of the example aspects disclosed above can be described as, but not limited to, the following supplementary notes.

### (Supplementary Note 1)

A method of a communication apparatus, the method comprising:
sending a message,
wherein the message includes a request to send information,
wherein the information includes at least one of identifier of a user equipment (UE), a location information where the UE locates, video information around the UE, photo information around the UE, sound information around the UE, temperature information around the UE, vital information of a user of the UE, and contact information of the UE; and
receiving the information after sending the message.

### (Supplementary Note 2)

The method according to supplementary note 1,
wherein the message is sent in a case where disaster occurs.

### (Supplementary Note 3)

The method according to supplementary note 1 or 2,
wherein the information includes information indicating whether the user of the UE is safe.

### (Supplementary Note 4)

A method of a user equipment (UE), the method comprising:
receiving a message,
wherein the message includes a request to send information,
wherein the information includes at least one of identifier of the UE, a location information where the UE locates, video information around the UE, photo information around the UE, sound information around the UE, temperature information around the UE, vital information of a user of the UE, and contact information of the UE; and
sending the information after receiving the message.

### (Supplementary Note 5)

The method according to supplementary note 4,
wherein the message is received in a case where disaster occurs.

### (Supplementary Note 6)

The method according to supplementary note 4 or 5,
wherein the information includes information indicating whether the user of the UE is safe.

### (Supplementary Note 7)

A communication apparatus comprising:
means for sending a message,
wherein the message includes a request to send information,
wherein the information includes at least one of identifier of a user equipment (UE), a location information where the UE locates, video information around the UE, photo information around the UE, sound information around the UE, temperature information around the UE, vital information of a user of the UE, and contact information of the UE; and
means for receiving the information after sending the message.

### (Supplementary Note 8)

The communication apparatus according to supplementary note 7,
wherein the message is sent in a case where disaster occurs.

### (Supplementary Note 9)

The communication apparatus according to supplementary note 7 or 8,
wherein the information includes information indicating whether the user of the UE is safe.

### (Supplementary Note 10)

A user equipment (UE) comprising:
means for receiving a message,
wherein the message includes a request to send information,
wherein the information includes at least one of identifier of the UE, a location information where the UE locates, video information around the UE, photo information around the UE, sound information around the UE, temperature information around the UE, vital information of a user of the UE, and contact information of the UE; and
means for sending the information after receiving the message.

### (Supplementary Note 11)

The UE according to supplementary note 10,
wherein the message is received in a case where disaster occurs.

### (Supplementary Note 12)

The UE according to supplementary note 10 or 11,
wherein the information includes information indicating whether the user of the UE is safe.

This application is based upon and claims the benefit of priority from Indian Patent Application number 202211014351, filed on Mar. 16, 2022, the disclosure of which is incorporated herein in its entirety by reference.

### REFERENCE SIGNS LIST

3 UE
31 TRANSCEIVER CIRCUIT
32 ANTENNA
33 CONTROLLER
34 USER INTERFACE
35 USIM
36 MEMORY
361 OPERATING SYSTEM
362 COMMUNICATIONS CONTROL MODULE
3621 TRANSCEIVER CONTROL MODULE
363 LIFEGUARD APL
3631 DATA STORAGE
5 RAN NODE
51 TRANSCEIVER CIRCUIT
52 ANTENNA
53 NETWORK INTERFACE
54 CONTROLLER
55 MEMORY
551 OPERATING SYSTEM
552 COMMUNICATIONS CONTROL MODULE
5521 TRANSCEIVER CONTROL MODULE
553 LIFEGUARD APL
5531 DATA STORAGE
60 RU
601 TRANSCEIVER CIRCUIT
602 ANTENNA
603 NETWORK INTERFACE
604 CONTROLLER
605 MEMORY
6051 OPERATING SYSTEM
6052 COMMUNICATIONS CONTROL MODULE
60521 TRANSCEIVER CONTROL MODULE
61 DU
611 TRANSCEIVER CIRCUIT
612 NETWORK INTERFACE
613 CONTROLLER
614 MEMORY
6141 OPERATING SYSTEM
6142 COMMUNICATIONS CONTROL MODULE
61421 TRANSCEIVER CONTROL MODULE
62 CU
621 TRANSCEIVER CIRCUIT
622 NETWORK INTERFACE
623 CONTROLLER
624 MEMORY
6241 OPERATING SYSTEM
6242 COMMUNICATIONS CONTROL MODULE
62421 TRANSCEIVER CONTROL MODULE
7 CORE NETWORK
70 AMF
701 TRANSCEIVER CIRCUIT
702 NETWORK INTERFACE
703 CONTROLLER
704 MEMORY
7041 OPERATING SYSTEM
7042 COMMUNICATIONS CONTROL MODULE
70421 TRANSCEIVER CONTROL MODULE
71 SMF
711 TRANSCEIVER CIRCUIT
712 NETWORK INTERFACE
713 CONTROLLER
714 MEMORY
7141 OPERATING SYSTEM
7142 COMMUNICATIONS CONTROL MODULE
71421 TRANSCEIVER CONTROL MODULE
72 UPF
721 TRANSCEIVER CIRCUIT
722 NETWORK INTERFACE
723 CONTROLLER
724 MEMORY
7241 OPERATING SYSTEM
7242 COMMUNICATIONS CONTROL MODULE
72421 TRANSCEIVER CONTROL MODULE
73 PCF
731 TRANSCEIVER CIRCUIT
732 NETWORK INTERFACE
733 CONTROLLER
734 MEMORY
7341 OPERATING SYSTEM
7342 COMMUNICATIONS CONTROL MODULE
73421 TRANSCEIVER CONTROL MODULE
74 AUSF
741 TRANSCEIVER CIRCUIT
742 NETWORK INTERFACE
743 CONTROLLER
744 MEMORY
7441 OPERATING SYSTEM
7442 COMMUNICATIONS CONTROL MODULE
74421 TRANSCEIVER CONTROL MODULE
75 UDM
751 TRANSCEIVER CIRCUIT
752 NETWORK INTERFACE
753 CONTROLLER
754 MEMORY
7541 OPERATING SYSTEM
7542 COMMUNICATIONS CONTROL MODULE
75421 TRANSCEIVER CONTROL MODULE
76 NWDAF
761 TRANSCEIVER CIRCUIT
762 NETWORK INTERFACE
763 CONTROLLER
764 MEMORY
7641 OPERATING SYSTEM
7642 COMMUNICATIONS CONTROL MODULE
76421 TRANSCEIVER CONTROL MODULE
77 NEF
771 TRANSCEIVER CIRCUIT
772 NETWORK INTERFACE
773 CONTROLLER
774 MEMORY
7741 OPERATING SYSTEM
7742 COMMUNICATIONS CONTROL MODULE
77421 TRANSCEIVER CONTROL MODULE
78 NSACF
781 TRANSCEIVER CIRCUIT
782 NETWORK INTERFACE
783 CONTROLLER
784 MEMORY
7841 OPERATING SYSTEM
7842 COMMUNICATIONS CONTROL MODULE
78421 TRANSCEIVER CONTROL MODULE
20 DATA NETWORK
201 IMS
2011 TRANSCEIVER CIRCUIT
2012 NETWORK INTERFACE
2013 CONTROLLER
2014 MEMORY
20141 OPERATING SYSTEM
20142 COMMUNICATIONS CONTROL MODULE
201421 TRANSCEIVER CONTROL MODULE
202 PSAP
2021 TRANSCEIVER CIRCUIT
2022 NETWORK INTERFACE
2023 CONTROLLER
2024 MEMORY
20241 OPERATING SYSTEM
20242 COMMUNICATIONS CONTROL MODULE
202421 TRANSCEIVER CONTROL MODULE

What is claimed is:

1. A method of a communication apparatus, the method comprising:
sending a message,
wherein the message includes a request to send information,
wherein the information includes at least one of identifier of a user equipment (UE), a location information where the UE locates, video information around the UE, photo information around the UE, sound information around the UE, temperature information around the UE, vital information of a user of the UE, and contact information of the UE; and
receiving the information after sending the message.

2. The method according to claim 1,
wherein the message is sent in a case where disaster occurs.

3. The method according to claim 1,
wherein the information includes information indicating whether the user of the UE is safe.

4. A method of a user equipment (UE), the method comprising:
receiving a message,
wherein the message includes a request to send information,
wherein the information includes at least one of identifier of the UE, a location information where the UE locates, video information around the UE, photo information around the UE, sound information around the UE, temperature information around the UE, vital information of a user of the UE, and contact information of the UE; and
sending the information after receiving the message.

5. The method according to claim 4,
wherein the message is received in a case where disaster occurs.

6. The method according to claim 4,
wherein the information includes information indicating whether the user of the UE is safe.

7.-9. (canceled)

10. A user equipment (UE) comprising:
at least one memory storing instructions; and
at least one processor configured to execute the instructions to:
receive a message,
wherein the message includes a request to send information,
wherein the information includes at least one of identifier of the UE, a location information where the UE locates, video information around the UE, photo information around the UE, sound information around the UE, temperature information around the UE, vital information of a user of the UE, and contact information of the UE; and
send the information after receiving the message.

11. The UE according to claim 10,
wherein the message is received in a case where disaster occurs.

12. The UE according to claim 10,
wherein the information includes information indicating whether the user of the UE is safe.
